(19) United States
(12) Patent Application Publication
(10) Pub. No.: US 2013/0340574 A1
(43) Pub. Date: Dec. 26, 2013

(54) WRENCH RATCHET MECHANISMS AND WRENCHES

(71) Applicant: Nigel A. Buchanan, New Gilston (GB)

(72) Inventor: Nigel A. Buchanan, New Gilston (GB)

(73) Assignee: AMERICAN GREASE STICK COMPANY, Muskegon, MI (US)

(21) Appl. No.: 13/819,753

(22) PCT Filed: Aug. 30, 2011
(86) PCT No.: PCT/GB2011/051622

§ 371 Date: Sep. 11, 2013

(30) Foreign Application Priority Data
Aug. 30, 2010 (EP) 10174569.3
Feb. 18, 2011 (GB) 1102894.1

(51) Int. Cl. B25B 13/46

(52) U.S. Cl. CPC B25B 13/463
USPC 81/60

(57) ABSTRACT

A wrench ratchet mechanism has a driven member, a housing having a chamber in which said driven member is at least partially received and a torque transmitter disposed between the housing and the driven member to transmit an applied torque from the housing to the driven member. The torque transmitter is deformable from a non-torque transmitting condition to a torque transmitting condition in response to rotation of the housing in a first direction and returnable to the non-torque transmitting condition in response to rotation of the housing in a second direction that is opposite the first direction.

### FIELD OF THE INVENTION

The invention relates to wrench ratchet mechanisms and wrenches (often referred to in the United Kingdom as spanners).

### BACKGROUND TO THE INVENTION

Known ratchet wrenches may comprise a wrench head that houses a driven member. The driven member may be provided with an aperture shaped to receive an item that is to be driven. For example, the aperture may be a hexagonal aperture sized to receive a particular size of fastener head/nut. Alternatively, the driven member may comprise a spigot that projects from the wrench head to allow the wrench head to be connected to a drive socket or the like.

The driven member may have a circumferentially extending surface provided with a series of teeth that are engageable by the teeth of a pawl that is fixed to the wrench head. The engagement between the pawl and teeth is such that if the wrench head is turned in a first direction the rotation of the wrench head is transmitted to the driven member. If the wrench head is turned in a second (opposite) direction the pawl slides over the teeth on the driven member. By this means the wrench can apply a torque to an item by turning the wrench head in the first direction and the wrench handle can be repositioned with respect to the item by turning the wrench head in the second direction. Wrenches of this type may be provided with a pair of pawls that are selectively engageable with the driven member by means of a switch. The torque applying and handle repositioning directions of the wrench can be reversed by operation of the switch.

### SUMMARY OF THE INVENTION

The invention provides a wrench ratchet mechanism comprising a driven member, a housing having a chamber in which said driven member is at least partially received and a torque transmitter disposed between said housing and said driven member to transmit an applied torque from said housing to said driven member, said driven member having an axis of rotation and being rotatable about said axis in response to said applied torque and said torque transmitter being deformable from a non-torque transmitting condition to a torque transmitting condition in response to rotation of said housing in a first direction and returnable to said non-torque transmitting condition in response to rotation of said housing in a second direction that is opposite said first direction.

The invention also includes a wrench comprising a ratchet wrench head and a lever connected with said ratchet wrench head, said ratchet wrench head comprising:

a body defining a chamber having an inwards facing sidewall;

a driven member at least partially housed in said chamber and rotatable therein about an axis of rotation, said driven member having an outwards facing sidewall and a formation to engage an object to which a torque is to be applied;

at least one arcuate member disposed between said inwards and outwards facing sidewalls; and

a cam system configured to shape change said at least one arcuate member from a non-torque transmitting shape to a torque transmitting shape in response to rotation of said housing in a first direction,

wherein when in said torque transmitting shape said at least one arcuate member is forced into locking engagement with said body and said driven member to lock said driven member to said body whereby a torque applied to said body by said lever arm is transmitted to said driven member via said at least one arcuate member to be applied to said object.

The invention also includes a ratchet wrench comprising:

a housing having an inner sidewall that at least partially defines a generally cylindrical passage;

a socket element received in said passageway and comprising an outer sidewall; and

a partial ring element disposed between said inner sidewall of said housing and said outer surface of said socket element,

wherein said partial ring expands responsive to rotation of said housing relative to said socket element in a first direction to engage said housing and cause said housing and said socket element to rotate together and contracts responsive to rotation of said housing relative to said socket element in a second direction opposite said first direction to allow for relative movement between said housing and said socket element.

The invention also includes a ratchet wrench comprising:

a housing having an inner sidewall that at least partially defines a generally cylindrical passage;

a socket element received in said passage and comprising an outer sidewall; and

a partial ring element disposed between said inner sidewall of said housing and said outer sidewall of said socket element,

wherein when said housing is rotated in a first direction, said partial ring element moves relative to said socket over at least one camming surface that causes said partial ring element to expand radially outwardly towards an expanded form, whereby an outer surface of said partial ring element engages said inner surface of said housing so as to rotate said socket element with said housing in said first direction and

wherein when said housing is rotated in a second direction that is opposite said first direction, said partial ring element moves relative to said socket element in an opposite direction to allow said partial ring element to contract towards a contracted form so as to allow relative rotation between said partial ring element and said housing when said housing is rotated in said second direction.

The invention also includes a ratchet wrench comprising:

a housing having an inner sidewall that at least partially defines a generally cylindrical passage;

a socket element received in said passage and comprising an outer sidewall having a plurality of angled or ramped teeth therearound; and

a partial ring element disposed between said inner sidewall of said housing and said outer sidewall of said socket element, said partial ring element comprising an outer surface for engaging said inner sidewall of said housing and an inner sidewall having a plurality of angled or ramped teeth for engaging said angled or ramped teeth of said outer sidewall of said socket element,

wherein when said housing is rotated in a first direction relative to said socket element, said angled or ramped teeth of said partial ring element move along said angled or ramped teeth of said socket element to urge said partial ring element radially outward towards an expanded form, whereby said outer sidewall of said partial ring element engages said inner sidewall of said housing so as to rotate said socket element with said housing in said first direction, and

wherein when said housing is rotated in a second direction relative to said socket element and opposite said first direction, said angled or ramped teeth of said partial ring element move along said angled or ramped teeth of said socket element in an opposite direction and allow said partial ring element to contract towards a contracted form so as to allow relative rotation between said partial ring element and said housing when said housing is rotated in said second direction.

The invention also includes a wrench ratchet mechanism comprising: a driven member having an outer sidewall;

a housing having an inwards facing sidewall that at least partially defines a passage in which said driven member is at least partially received, said passage having a longitudinal axis defining an axial direction; and

an arcuate torque transmitter disposed between said driven member and said housing and extending at least partially around said driven member in a circumferential direction thereof,

said torque transmitter comprising an outer sidewall facing said inwards facing sidewall of said housing and an inner sidewall facing said outer sidewall of said driven member and in response to rotation of said housing in a first direction being movable between a torque transmitting condition in which it causes said driven member to rotate with said housing and a non-torque transmitting condition in which said housing can rotate relative to said driven member, and

said torque transmitter being configured such that when in said torque transmitting condition in said circumferential direction there is contact between:

i) said inner sidewall of said torque transmitter and said outer sidewall of said driven member through at least 90 degrees of an imaginary circle extending around said driven member between said driven member and said torque transmitter; and

ii) said outer sidewall of said torque transmitter and said inwards facing sidewall of said housing through at least 90 degrees of an imaginary circle extending around said torque transmitter between said inwards facing sidewall and said torque transmitter.

The invention also includes a wrench comprising a ratchet wrench head and a lever connected with said ratchet wrench head, said ratchet wrench head comprising:

a housing, an output drive member at least partially housed in a generally cylindrical passage provided in said housing and rotatable in said passage about an axis of rotation and a split ring disposed in said passage between an inwards facing sidewall of said passage and an outwards facing sidewall of said output drive member, said split ring having a first tooth set engagable with a second tooth set that is provided on said inwards facing sidewall of said passage such that when said housing is rotated in a first direction said split ring is rotated with said housing to deform said split ring to a condition in which said split ring locks said housing to said output drive member and said first tooth set being disengageable from said second tooth set to permit rotation of said housing relative to said split ring when said housing is rotated in a second direction opposite said first direction to at least one position at which said split ring can at least partially deform towards said axis of rotation.

The invention also includes a wrench comprising a ratchet wrench head and a lever connected with said ratchet wrench head, said ratchet wrench head comprising:

a housing, an output drive member at least partially housed in a generally cylindrical passage provided in said housing and rotatable in said passage about an axis of rotation and a split ring disposed in said passage between an inwards facing sidewall of said passage and an outwards facing sidewall of said output drive member, said split ring having a first end provided with an inwards facing projection received in a recess provided in said outwards facing sidewall of said output drive member and being engaged with said inwards facing sidewall of said chamber such that when said housing is rotated in a first direction said spit ring is deformed to lock said output drive member to said housing for rotation therewith. Rotation of said housing in a second direction opposite said first direction may permit said split ring to resile to a condition in which said engagement with said inwards facing side wall of said chamber can be overcome to permit rotation of said housing relative to said split ring in said second direction.

The invention also comprises a ratchet wrench comprising:

a housing comprising a passageway having an inner surface;

a drive element received in said passageway and having an outer surface;

a locking element disposed between said inner surface of said housing and said outer surface of said drive element, wherein said locking element at least partially circumscribes said outer surface of said drive element; and wherein said drive element and said locking element cooperate to radially expand said locking element responsive to rotation of said housing relative to said drive element in a first direction to engage said locking element with said inner surface of said housing and said outer surface of said drive element to substantially secure said housing relative to said drive element and to cause said housing and said drive element to rotate together.

Said locking element may be biased towards an expanded state and contract towards said contracted state when said housing is rotated relative to said drive element in a second direction opposite said first direction.

Said outer surface of said drive element and an inner surface of said locking element may be configured to and cooperate to cause said locking element to expand responsive to rotation of said housing relative to said drive element in said first direction.

Said outer surface of said drive element may comprise a plurality of ramp portions that engage a plurality of corresponding ramp portions of said inner surface of said locking element.

Said ramp portions may comprise curved ramp portions.

Said ramp portions may cooperate to radially expand said locking element to wedge said locking element between said drive element and said housing at multiple locations around said drive element.

When said locking element is radially expanded and wedged between said drive element and said housing, said inner surface of said locking element may contact at least about 30 percent of said outer surface of said drive element.

When said locking element is radially expanded and wedged between said drive element and said housing, an outer surface of said locking element may contact at least about 75 percent of said inner surface of said housing.

Said inner surface of said housing and an outer surface of said locking element may be configured to limit relative movement therebetween when said locking element is expanded to engage said housing.

Said inner surface of said housing and said outer surface of said locking element may comprise a plurality of teeth that are configured to mesh together when said locking element is expanded to engage said housing.

Said locking element may contract responsive to rotation of said housing relative to said drive element in a second direction opposite said first direction to at least partially disengage from at least one of said inner surface of said housing and said outer surface of said drive element to allow for relative movement between said housing and said drive element.

Said locking element may be disposed between said drive element and said housing such that, when said housing is rotated in said second direction, at least a portion of said locking element is separated from said inner surface of said housing and, when said housing is rotated in said first direction, an outer surface of said locking element is engaged with said inner surface of said housing.

The invention also includes a ratchet wrench comprising:

a housing comprising a generally cylindrical passageway having an inner side surface;

a drive element received in said passageway and comprising an outer surface;

a partial ring element disposed between said inner annular surface of said housing and said outer surface of said drive element; and

wherein said partial ring expands responsive to rotation of said housing relative to said drive element in a first direction to engage said housing and cause said housing and said drive element to rotate together, and wherein said partial ring contracts responsive to rotation of said housing relative to said drive element in a second direction opposite said first direction to allow for relative movement between said housing and said drive element.

The invention also includes a ratchet wrench comprising:

a housing comprising a generally cylindrical passageway having an inner side surface;

a drive element received in said passageway and comprising an outer surface;

a partial ring element disposed between said inner side surface of said housing and said outer surface of said drive element; and

wherein said partial ring is expandable and contractible responsive to rotation of said housing relative to said drive element, and wherein said partial ring element expands when said housing is rotated in a first direction relative to said drive element to impart corresponding rotation of said drive element, and wherein said partial ring element contracts when said housing is rotated in a second direction relative to said drive element to allow for relative movement of said housing about said drive element.

The invention also includes a ratchet wrench comprising:

a housing comprising a generally cylindrical passageway having an inner side surface;

a drive element received in said passageway and comprising an outer surface;

a partial ring element disposed between said inner side surface of said housing and said outer surface of said drive element; and

wherein, when said housing is rotated in a first direction relative to said drive element, said drive element moves relative to said partial ring element to urge said partial ring element radially outward towards an expanded form, whereby an outer surface of said partial ring element substantially non-movably engages said inner surface of said housing so as to rotate said drive element with said housing in said first direction; and

wherein, when said housing is rotated in a second direction relative to said drive element and opposite said first direction, said drive element moves relative to said partial ring element in an opposite direction to allow said partial ring element to contract towards a contracted form so as to allow relative rotation between said partial ring element and said housing when said housing is rotated in said second direction.

The invention also includes a ratchet wrench comprising:

a housing comprising a generally cylindrical passageway having an inner side surface;

a drive element received in said passageway and comprising an outer surface having a plurality of angled or ramped teeth therearound;

a partial ring element disposed between said inner annular surface of said housing and said outer surface of said drive element, wherein said partial ring element comprises an outer surface for engaging said inner side surface of said housing, and wherein said partial ring element comprises an inner surface having a plurality of angled or ramped teeth for engaging said angled or ramped teeth of said outer surface of said drive element; and

wherein, when said housing is rotated in a first direction relative to said drive element, said angled or ramped teeth of said drive element move along said angled or ramped teeth of said partial ring element and urge said partial ring element radially outward towards an expanded form, whereby said outer surface of said partial ring element engages said inner side surface of said housing so as to rotate said drive element with said housing in said first direction; and

wherein, when said housing is rotated in a second direction relative to said drive element and opposite said first direction, said angled or ramped teeth of said drive element move along said angled or ramped teeth of said partial ring element in an opposite direction and allow said partial ring element to contract towards a contracted form so as to allow relative rotation between said partial ring element and said housing when said housing is rotated in said second direction.

The invention also includes a ratchet wrench comprising:

a housing comprising a generally cylindrical passageway having an inner surface, said inner surface comprising a plurality of protrusions established therearound;

a drive element received in said passageway and comprising an outer surface having a plurality of angled or ramped teeth therearound;

a partial ring element disposed between said inner surface of said housing and said outer surface of said drive element, wherein said partial ring element comprises an outer surface having a plurality of protrusions for engaging said protrusions of said inner annular surface of said housing, and wherein said partial ring element comprises an inner surface having a plurality of angled or ramped teeth for engaging said angled or ramped teeth of said outer surface of said drive element, and wherein said partial ring element is biased towards an initial form having a reduced diameter and is expandable towards an expanded form having a larger diameter; and

wherein, when said housing is rotated in a first direction relative to said drive element, said angled or ramped teeth of said drive element move along said angled or ramped teeth of said partial ring element and urge said partial ring element towards said expanded form, whereby said protrusions of said outer surface of said partial ring element engage and mesh with said protrusions of said inner surface of said housing to fixedly secure said partial ring element relative to said housing so as to rotate said drive element with said housing in said first direction; and

wherein, when said housing is rotated in a second direction opposite said first direction and relative to said drive element, said angled or ramped teeth of said drive element move along said angled or ramped teeth of said partial ring element in an opposite direction and allow said partial ring element to contract towards its initial form, whereby said protrusions of said outer surface of said partial ring element only partially engage said protrusions of said inner surface of said housing so as to allow relative rotation between said partial ring element and said housing when said housing is rotated in said second direction

### BRIEF DESCRIPTION OF THE DRAWINGS

In order that the invention may be well understood, some examples thereof, which are given by way of example only, will now be described with reference to the drawings in which:

FIG. 1 is an exploded perspective view of a wrench provided with a ratchet wrench head;

FIG. 2 is a schematic plan view of a driven member and a torque transmitting member of the ratchet wrench head in a first position;

FIG. 3 is a schematic plan view of the driven member and torque transmitting member of the ratchet wrench head in a second position;

FIG. 4 is a schematic plan view of a first possible modification to the ratchet wrench head of FIG. 1 with an enlarged portion of the plan view circled;

FIG. 5 is a schematic plan view of a second possible modification to the ratchet wrench head of FIG. 1 with an enlarged portion of the plan view circled;

FIG. 6 is an exploded perspective view of a second example of a wrench provided with a ratchet wrench head;

FIG. 7 is a schematic plan view of the wrench of FIG. 6;

FIG. 8 is an exploded perspective view of a third example of a wrench provided with a ratchet wrench head;

FIG. 9 is an exploded perspective view of a torque transmitter and driven member of the wrench of FIG. 8;

FIG. 10 is a schematic plan view of the torque transmitter and driven member of FIG. 9 in a non-torque applying rest condition;

FIG. 11 is a view corresponding to FIG. 10 showing the parts in a non-torque applying repositioning condition;

FIG. 12 is a view corresponding to FIG. 10 showing the parts in a torque applying condition;

FIG. 13 is a schematic plan illustration of a fourth example of a wrench provided with a ratchet wrench head shown in a non-torque applying rest condition including a circled enlargement of a portion of the wrench head;

FIG. 14 shows the enlarged portion of FIG. 13 in a torque applying condition;

FIG. 15 is a schematic plan view of fourth example of a wrench provided with a ratchet wrench head;

FIG. 16 is an enlargement of a portion of the wrench of FIG. 15 showing relative positions of parts of the wrench when in a non-torque applying rest condition;

FIG. 17 is an enlargement of a portion of the wrench of FIG. 15 showing relative positions of parts of the wrench when in a torque applying condition;

FIG. 18 is an enlargement of a portion of the wrench of FIG. 15 showing relative positions of parts of the wrench when in a non-torque applying repositioning condition;

FIG. 19 is a view corresponding to FIG. 16;

FIG. 20 is an exploded view of a fifth example of a wrench provided with a wrench ratchet mechanism;

FIG. 21 is a plan view of the wrench of FIG. 21;

FIG. 22 is an enlargement of a portion of the wrench of FIG. 20 showing an optional modification;

FIG. 23 is a perspective view of a driven member that may be incorporated in any of the wrenches shown in FIGS. 1 to 22;

FIG. 24 shows schematic side views of three configurations of ratchet wrench head;

FIG. 25 is a plan view of a ratchet wrench head as shown in FIG. 25; and

FIG. 26 shows a tooth form that may used in example of the wrench ratchet mechanism.

### DETAILED DESCRIPTION

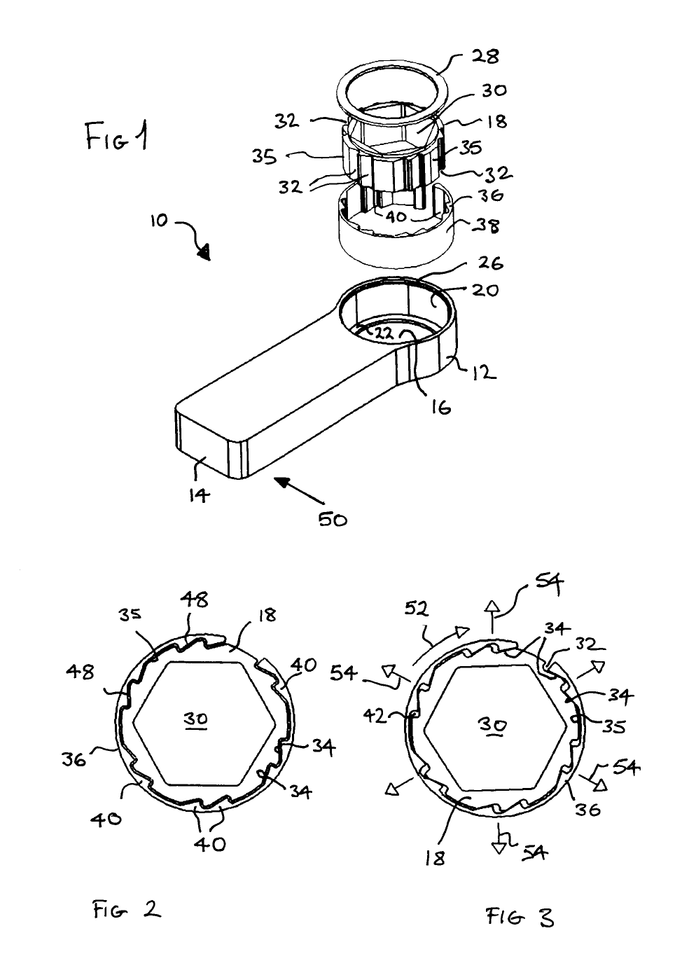

Referring to FIGS. 1 to 3, a wrench 10 comprises a wrench head, or housing, 12 and a lever arm, or handle, 14. The wrench head 12 is an annular body provided at one end of the lever arm 14 and is typically, but not necessarily, integral with an end of the lever arm. The wrench head 12 has a stepped through-hole, or passage, that defines a generally cylindrical chamber 16 in which a driven member 18 is housed. The chamber 16 has a circumferentially extending sidewall 20 and an annular support wall 22 defined by a change of diameter of the stepped though-hole. The support wall 22 may extend substantially perpendicular to the sidewall 20. The driven member 18 seats on and is supported by the support wall 22 such that it is rotatable about an axis of rotation defined by the chamber 316. A groove 26 is provided in the end of the sidewall 20 that is disposed furthest from the support wall 22. The groove 26 is to receive the outer periphery of a sealing element 28. The sealing element 28 may be a plastics ring that snap fits into the groove 26 to provide a seal against dust and dirt.

The driven member 18 is a generally cylindrical body provided with an axially extending through-hole, or socket, 30. In the illustrated example the socket 30 is hexagonal in cross-section to allow it to receive a particular size of nut or fastener head. It is to be understood that this is not to be taken as limiting and that the socket may be shaped to receive any form of fastener or other object, such as the end of a shaft, to which a torque is to be applied.

The outer sidewall of the driven member 18 is provided with a plurality of recesses, or notches, 32. The recesses 32 define respective camming surfaces, or ramps, 34. The ramps 34 are inclined with respect to the circumferential direction of the outer sidewall of the driven member so as to have a radius that increases substantially continuously in the lengthways direction of the ramp. The portions of the sidewall between the recesses 32 define bearing surfaces 35. The bearing surfaces 135 have a substantially constant radius.

The chamber 16 additionally houses a torque transmitter that in this example takes the form of a torque transmitting member that comprises a resilient split ring 36. The split ring 36 is disposed between the wrench head 12 and driven member 18. The driven member 18 and split ring 36 are held in the chamber 16 between the support wall 22 and sealing element 28, which serve to limit relative axial movement between the wrench head 312 and the driven member and split ring.

The outer sidewall 38 of the split ring 36 engages the sidewall 20 of the chamber 18. The diameter of the split ring 36 is slightly greater than that of the sidewall 20 so that the ring is slightly compressed when fitted in the chamber 16. The split ring 36 is thus spring biased into engagement with sidewall 20. The difference in the diameters is selected to provide a desired frictional engagement between the split ring 36 and the sidewall 20 so that the split ring will rotate with the wrench head 12 unless a resistance sufficient to overcome the frictional engagement is applied to the ring.

The inner sidewall of the split ring 36 is provided with a series of projections, or wedge sections, 40 to define a profile that complements the profile of the outer sidewall of the driven member 18 such that the driven member fits into the split ring like a key, the parts being assembled by relative axial movement thereof. The wedge sections 40 are received in the recesses 32 in the outer sidewall of the driven member 18. The bearing surfaces 35 are received in recesses 42 that are defined between the wedge sections 40. The wedge sections 40 define inclined surfaces 48 for engagement with the ramps 34. The inclined surfaces 48 are inclined in the circumferential direction of the split ring 36 so as to have a radius that increases progressively in the lengthways direction of the surface.

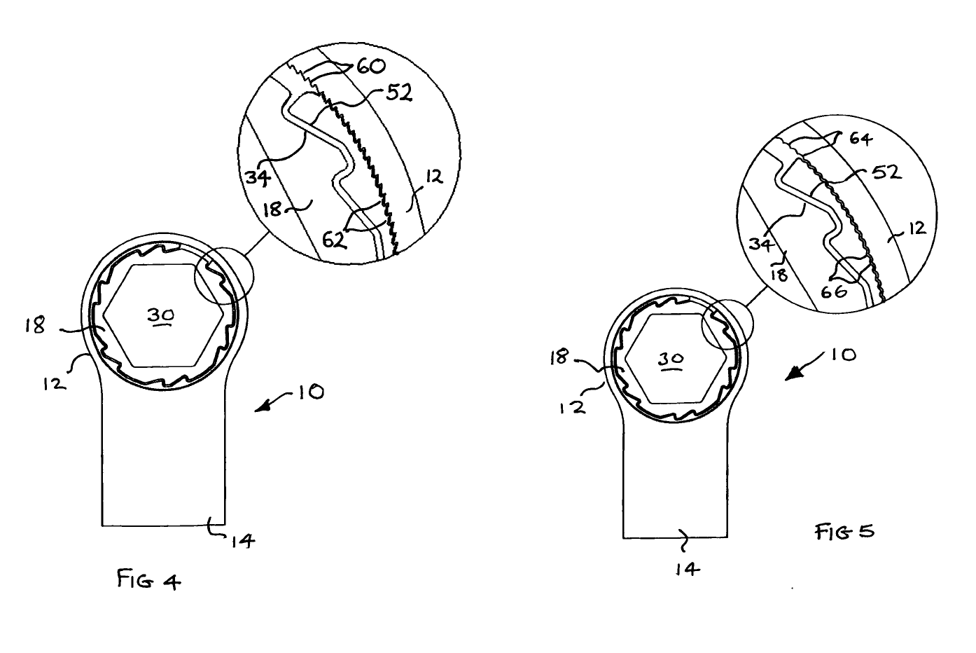

FIG. 2 shows the relative positions of the driven member 18 and split ring 36 when the wrench is at rest (ie when the split ring 36 is in a non-torque transmitting condition). In order to apply a clockwise directed torque to an object (not shown) that is received in the socket 30, a clockwise force is applied to the lever arm 14 as indicated by the arrow 50 in FIG. 1. The applied force causes the wrench head 12 to turn clockwise. Due to the frictional engagement between the sidewall 38 of the split ring 36 and the chamber sidewall 20, the split ring 36 moves clockwise with the wrench head 12 as indicated by the arrow 52 in FIG. 3. At this stage the driven member 18 does not move and as the split ring 36 moves about the driven member the relative movement of the two parts causes the inclined surfaces 48 of the split ring to move along the mutually inclined ramps 34 of the driven member. As the inclined surfaces 48 slide over the ramps 34, the split ring is deformed. Specifically, the split ring is caused to expand radially outwardly as indicated by the arrows 54 in FIG. 3. The expansion of the split ring 36 causes it to more firmly engage the sidewall 20 of the chamber 16. As the force applied to the lever arm 14 is increased, the wedge sections 40 wedge between the ramps 34 and the sidewall 20 to lock the split ring 36 between the driven member 18 and wrench head 12 in a torque transmitting condition so that the applied torque is transmitted from the wrench head to the driven member via the split ring 36.

If the lever arm 14 needs to be repositioned during a torque applying operation, the wrench head 12 is turned anticlockwise by the application of an anticlockwise directed force applied to the lever arm. This causes the wrench head 12 and split ring 36 to rotate anticlockwise. As the split ring 36 rotates anticlockwise the inclined surfaces of the wedge sections 40 move back along the ramps 34, allowing the split ring to resile to the non-torque transmitting, rest, condition shown in FIG. 2 so that the only force holding the split ring in engagement with the wrench head is the frictional engagement caused by the resilience of the split ring. Provided the resistance to turning provided by the object received in the socket 30 is greater than the frictional engagement between the wrench head 12 and the split ring 36, the wrench head 12 can then be rotated anticlockwise relative to the split ring to reposition the lever arm 14. When the lever arm 14 is suitably repositioned, a clockwise torque can be applied to the object received in the socket 30 by applying a clockwise force to the lever arm and repeating the procedure described above.

FIG. 4 shows a first possible modification to the wrench 10. The modification comprises providing complementary saw teeth 60, 62 on the chamber sidewall and on the outer sidewall of the split ring 36. The engagement of the teeth 60, 62 increases the force causing the split ring to rotate with the wrench head when the wrench is rotated in a torque applying direction (clockwise as viewed in FIG. 4). This provides a more positive engagement between the two parts to ensure the split ring 36 will be reliably moved into locking engagement between the wrench head 12 and driven member 18 when the wrench is being used to apply a torque to an object received in the socket 30. However, there is a disadvantage with this arrangement as compared with the arrangement shown in FIGS. 1 to 3. Although the saw tooth profile of the teeth 60, 62 allows the teeth 60 on the wrench head 12 to slide over the teeth 62 on the split ring when the wrench head is rotated anticlockwise during repositioning of the lever arm 14, there will be a greater resistance to relative rotation of the wrench head and split ring. If the object received in the socket 30 does not provide sufficient resistance, the ratchet effect will not be obtainable other than by the operative gripping the object (assuming this is physically possible).

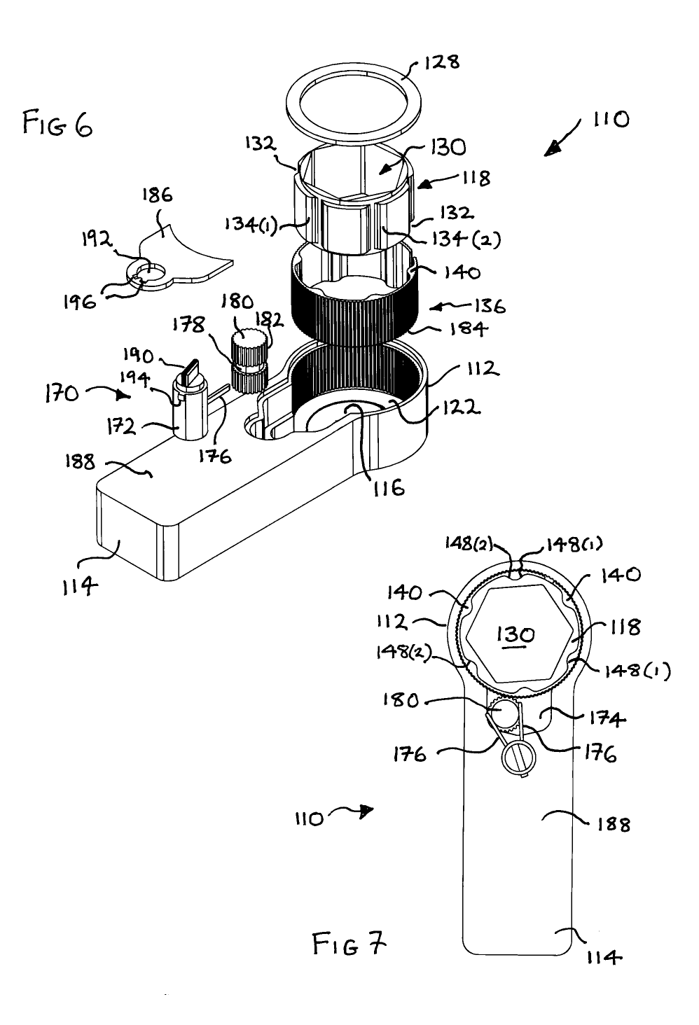

FIG. 5 shows a second possible modification to the wrench 10. The modification comprises the provision of complementary ridges 64, 66 instead of saw teeth. The ridges 64, 66 provide a greater degree of engagement between the outer sidewall of the split ring 36 and the sidewall of the chamber than in the example illustrated in FIG. 1 to assist in ensuring that the split ring moves with the wrench head during torque applying operations. However, they may provide a lower resistance to relative rotation of the wrench head 12 and split ring 36 during repositioning of the lever arm 14 than the saw teeth 60, 62.

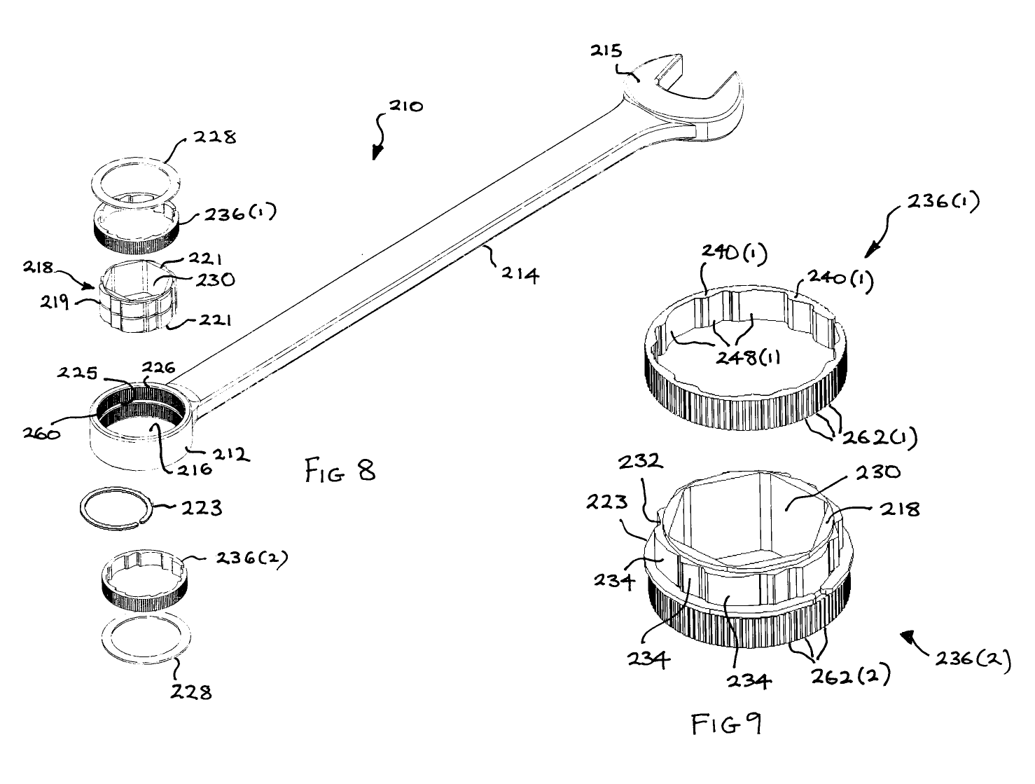

The wrench 10 shown in FIGS. 1 to 3 is uni-directional. In order to change the direction in which the wrench 10 is able to apply a torque to an object received in the socket 30, the wrench has to be flipped through 180°. FIGS. 6 and 7 illustrate an example of a wrench 110 that operates in a manner similar to the wrench 10, but is bidirectional. Parts of the wrench 110 that are the same as, or similar to, parts of the wrench 10 are given the same reference numerals incremented by 100 and may not be described again.

The driven member 118 is provided with recesses 132 that defined opposed pairs of mutually inclined ramps 134(1), 134(2). The ramps 134(1), 134(2) are separated by bearing surfaces 135.

The resilient split ring 136 is provided with projections, or wedge sections, 140 that are received in the recesses 132. The bearing surfaces 135 are received in recesses 142 defined between the wedge sections 140. The wedge sections 140 define oppositely facing inclined surfaces 148(1), 148(2) that are complementary to and engagable with the ramps 134(1), 134(2) of the driven member 118.

The wrench 110 has a switch 170 to switch the configuration of the wrench ratchet mechanism between a configuration that allows the application of a clockwise torque and an anticlockwise torque whilst maintaining the wrench in one orientation so that the wrench is capable of bi-directional operation. The switch 170 comprises a rotatable switch body 172 that is received in a recess 174 provided in the lever arm 114. The recess 174 opens into the chamber 116. The switch body 172 is provided with a pair of arms 176 that extend divergently away from the body. The arms 176 are received in a circumferentially extending groove 178 provided in a cylindrical member 180 that is disposed in the recess 174 intermediate the switch body 172 and the split ring 136. The cylindrical member 180 is provided with axially extending teeth 182 to engage axially extending teeth 184 provided on the radially outer sidewall of the split ring 136.

The switch body 172 and cylindrical member 180 are held in the recess 174 by a retaining plate 186 (omitted from FIG. 7 to allow the positioning of the switch body and cylindrical member 180 relative to the split ring to be seen. The retaining plate 186 seats in a groove that extends around the recess 174 so that the plate can lie substantially flush with the surface 188 of the lever arm 114 and may be secured, preferably releasably, to the lever arm by an suitable known securing technique. The switch body 172 has a reduced diameter end portion from which a generally planar rectangular grip 190 projects. The retaining plate 186 is provided with a through-hole 192 which is sized to receive the reduced diameter end portion of the switch body 172 and beyond which the grip 190 projects so that it may be grasped by a user. The switch body 172 is provided with a lock member 194 adjacent the reduced diameter end portion. The lock member is engagable in each of a pair of recesses 196 provided in the periphery of the through-hole 192 to lock the switch in respective switch positions.

Rotation of the switch body 172 between the switch positions causes the arms 184 to draw the cylindrical member 180 along an arcuate path across the recess 174. The engagement of the teeth 182, 184 causes the cylindrical member 180 and split ring 136 to rotate a small distance so that the wedge sections 140 are moved across their respective recesses 132. According to the direction in which the switch 170 is operated, the split ring 136 will be rotated clockwise or anticlockwise to bring one of the sets of inclined surfaces 148(1), 148(2) into engagement with the respective set of ramps 134(1), 134(2) defined by split ring 136. The wrench 110 is then set to apply a torque in a clockwise or anticlockwise direction (according to which set of ramps 134(1), 134(2) is engaged) when an appropriately directed input force is applied to the lever arm 112.

FIGS. 8 to 12 illustrate an example of a wrench 210 that operates in a manner similar to the wrench 10. Parts of the wrench 210 that are the same as, or similar to, parts of the wrench 10 are given the same reference numerals incremented by 200 and may not be described again.

Referring to FIG. 8, the wrench 210 comprises a wrench head 212 disposed at one end of a lever arm 214. Optionally, an open ended wrench head 215 may be provided at the end of the lever arm 214 opposite the end at which the wrench head 212 is disposed. In this example, the wrench heads 212, 215 are integral with the lever arm 214.

The wrench head 212 is an annular body having a through-hole that defines a chamber 216 that has a substantially constant diameter through-out the length thereof. The chamber 216 houses a driven member 218. The radially outer wall of the driven member 218 is provided with a circumferentially extending groove 219 that extends around the entire circumference of the driven member. The groove 219 is disposed substantially midway between the end faces 221 of the driven member. The groove 219 is fitted with a snap ring 223. The inner sidewall of the wrench head 212 is provided with a circumferentially extending groove 225 that is positioned substantially midway between the two open ends of the chamber 216 to receive the snap ring 223 so that the driven member 218 is positioned and retained within the chamber by engagement of the snap ring in the grooves 219, 225. The groove 219 in the driven member 218 has sufficient radial depth to permit the snap ring 223 to be compressed such that it is substantially contained within the groove to permit assembly of the driven member 218 within the chamber 216 by a pushing movement in the axial direction of the chamber. Once the snap ring 223 is disposed generally opposite the groove 225, the snap ring is able to expand radially outwardly so as to engage in the two grooves. The snap ring 223 locates the driven member 218 axially in the chamber 216 so that axial movement of the driven member is limited to the clearance provided between the snap ring and the grooves 219, 225 in which it is received.

In this example, the groove 225 in which the snap ring 223 is received is disposed approximately midway between the open ends of the chamber 216. In conventional ratchet wrench heads, the driven member is located axially by a snap ring disposed adjacent an end of the passage in which the driven member is received. The presence of a groove weakens the wrench head and if it is disposed at an edge of the wrench head, this weakening is located at a region vulnerable to shock, point, loads if the wrench head is dropped or otherwise abused. In order to avoid problems with breakage, conventional wrench heads have a relatively thick body in order to provide additional support around the groove. This is undesirable in that it increases the nominal diameter of the wrench head, making it less suitable for use in confined spaces. Having the groove 225 positioned away from the ends of the chamber 216 ensures that if the wrench is dropped or abused, any load that may be applied to the region in which the groove is located can be distributed more evenly through the wrench head body. Accordingly, the wrench head body is less in need of an increased thickness to protect against breakage. This means that the thickness of the wrench head body does not need to be as great as that of the body of a corresponding size of a conventional wrench allowing the wrench head to be smaller overall, thereby providing a wrench head that is better suited to working in confined spaces.

In the illustrated example, the groove 225 is disposed approximately midway between the ends of the chamber 216. This is not to be taken as limiting. The benefit in locating the groove away from the ends of the chamber is still obtainable if the groove is located within a 50% midrange of the height of the wrench head centred on mid-height. In the context of the illustrated example, the wrench head 212 and chamber 216 have a height measured in the axial direction of the chamber. A 50% midrange of that height centred on mid-height provides two end zones of the chamber disposed on either side of the midrange and each representing approximately 25% of the height.

A groove 226 (only one of which is visible) is provided at each end of chamber 216 to receive the outer periphery of respective sealing elements 228. The sealing elements 228 seat on respective steps defined by a reduced diameter portion of the driven member 218 adjacent the end faces 221. The sealing elements 228 may be plastics rings that snap-fit between the wrench head 212 and driven member 218 to provide a seal against dust and dirt.

In this example, the torque transmitter is a two part device comprising two resilient split rings 236(1), 236(2). The torque transmitter split rings 236(1), 236(2) are disposed between the driven member 218 and the inner sidewall of the wrench head, one on each side of the snap ring 223. In the axial direction of the chamber 216, each split ring 236(1), 236(2) is disposed between the snap ring 223 and a sealing element 228 such that the snap ring is sandwiched between the two split rings. In this way, the two split rings 236(1), 236(2) are retained in the chamber 216.

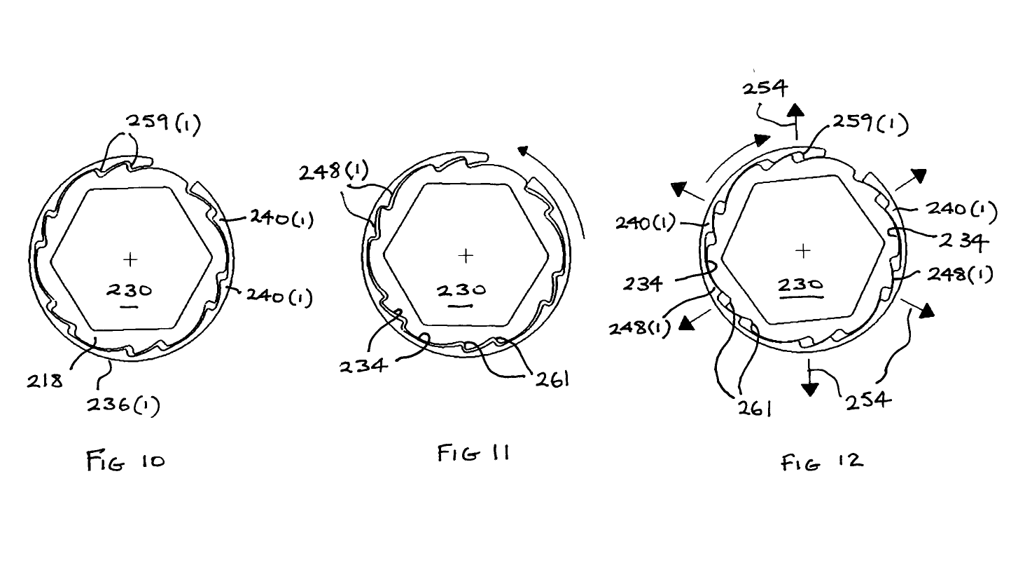

Referring to FIG. 9, the split rings 236(1), 236(2) are identical in construction and so for ease of description, only the features of the split ring 236(1) will be described. The split ring 236(1) has an inner sidewall provided with a series of circumferentially spaced projections, or wedge sections, 240(1) to define a profile that complements the profile of the outer sidewall of the driven member 218. The wedge sections 240(1) are received in respective recesses 232 provided on the outer sidewall of the driven member. The recesses 232 define respective camming surfaces, or ramps, 234. The ramps 234 are engagable by respective inclined surfaces 248(1) defined by the wedge sections 240(1) of the split ring 236(1).

The outer sidewall of each split ring 236(1), 236(2) is provided with a series of teeth 262(1), 262(2). The teeth 262(1), 262(2) are disposed in side by side relationship around the entire outer wall of the split rings and extend in substantially in parallel in the axial direction of the split rings, which is parallel to the axis of the chamber 216 and axis of rotation of the driven member 218. The teeth 262(1), 262(2) engagable with teeth 260 provided on the chamber sidewall. As can be seen in FIG. 8, the teeth 260 are effectively divided by the groove 225 into respective sets corresponding to the teeth of the split rings. The teeth 260 complement the teeth on the split rings 236(1), 236(2) and likewise extend in parallel side-by-side relationship and parallel to the axis of the chamber. The teeth 260 are provided around the entire circumference of the chamber sidewall.

The split rings 236(1), 236(2) cooperate with the wrench head 212 and driven member 218 to lock the driven member to the wrench head in a torque transmitting mode and release the driven member in a non-torque transmitting mode in similar fashion to the driven member 18 and split ring 36 of the wrench 10 shown in FIGS. 1 to 3. However, there are differences in the configuration and operation of the parts, which will now be described with reference to FIGS. 10 to 12.

Referring to FIG. 10, the driven member 218 and torque transmitter in the form of the split ring 236(1) are shown in a non-torque transmitting rest position. The second split ring 236(2) of the torque transmitter cannot be seen in FIGS. 10 to 12. However, it is to be understood that the description of the split ring 236(1) now given with reference to FIGS. 10 to 12 applies equally to the split ring 236(2).

In the condition shown in FIG. 10, split ring 236(1) is in a non-deformed relaxed condition in which it lightly engages the wrench head 212 and there is a small clearance between it and the driven member 218. Specifically, the teeth 260 of the chamber sidewall lightly engage the teeth 262(1) of the split ring. The respective diameters of the chamber 216 and slit ring 236(1) are selected such that when housed in the chamber 216 the split ring is slightly radially compressed so that the teeth 262(1) are held in engagement with the teeth 260 of the wrench head 312.

In order to apply a clockwise directed torque to an object (not shown) that is received in the socket 230 of the driven member 218, a clockwise force is applied to the lever arm 214 of the wrench 210. The applied force causes the wrench head to turn clockwise and due to the engagement between the teeth 260, 262(1), the split ring 236(1) turns clockwise with the wrench head. As the split ring 236(1) rotates the inclined faces 248 of the wedge sections 240(1) move along the mutually inclined ramps 234 of the driven member. As the inclined surfaces slide over the ramps 234, the split ring 236(1) is deformed. Specifically, the split ring 236(1) is caused to expand generally radially outwardly as indicated by the arrows 254 in FIG. 12. The expansion of the split ring 236(1) drives it into firmer engagement with the sidewall of the chamber 216. As the force applied to the lever arm 214 is increased, the wedge sections 240(1) wedge between the ramps 234 on the driven member 218 and the sidewall of the chamber 216 to lock the driven member to the wrench head 212 in a torque transmitting position so that torque applied via the lever arm 214 is transmitted to the driven member via the split ring 236(1).

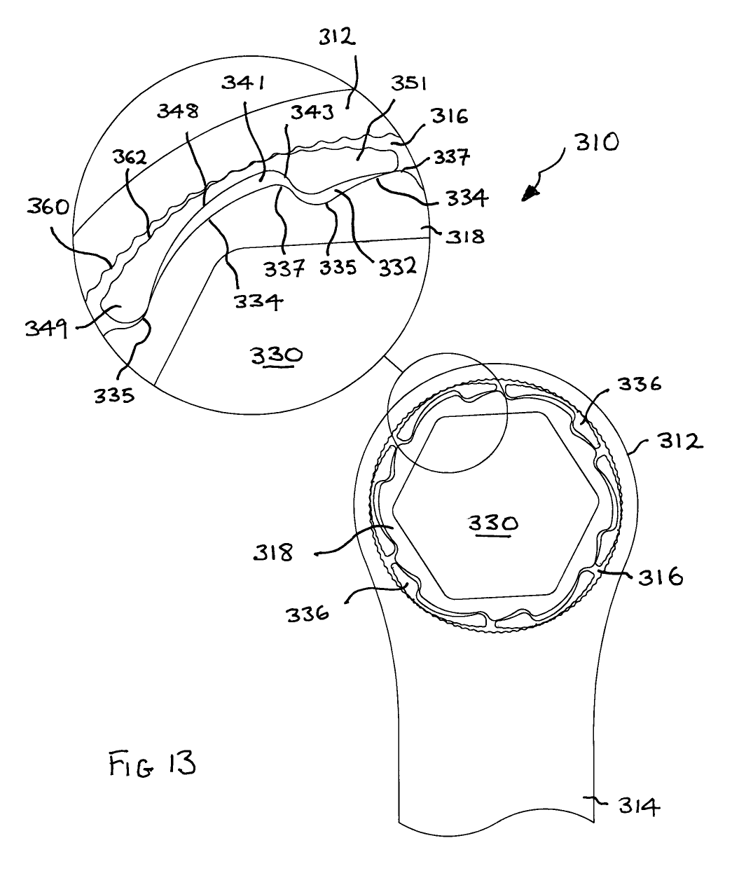

If the lever arm 214 needs to be repositioned during a torque applying operation, the wrench head 212 is turned anticlockwise from the position shown in FIG. 12 by the application of an anticlockwise directed force applied to the lever arm to put it in the non-torque applying repositioning condition shown in FIG. 11. This causes the wrench head 212 and split ring 236(1) to rotate anticlockwise. As the split ring 236(1) rotates anticlockwise the inclined surfaces of the wedge sections 240(1) move back along the ramps 234 of the driven member 218, allowing the split ring to resile to the condition shown in FIG. 11 so that the only force holding the split ring in engagement with the wrench head is the frictional engagement caused by the resilience of the split ring. Provided the resistance to turning provided by the object received in the socket 230 is greater than the frictional engagement between the wrench head 212 and the split ring 236, the wrench head 212 can then be rotated anticlockwise relative to the split ring to reposition the lever arm 214. When the lever arm 214 is suitably repositioned, a clockwise torque can be applied to the object received in the socket 230 by applying a clockwise force to the lever arm and repeating the procedure described above.

Referring to FIG. 11, it can be seen that in the non-torque applying repositioning condition, the split ring 236(1) has been rotated anticlockwise relative to the driven member 218 to a position in which the leading end shoulders 259(1) (as viewed in the direction of rotation) of the split ring 236(1) engage opposed shoulders 261 defined by the recesses 232 of the driven member. The engagement of these opposed shoulders prevents further anticlockwise rotation of the split ring 236(1). At this stage, in order for the wrench head 212 to rotate anticlockwise to allow repositioning of the lever arm 214, the split ring 236(1) flexes generally radially inwardly to permit the teeth 260 of the chamber sidewall to disengage and slide over the teeth 262(1) of the split ring 236(1). The flexing of the split ring 236(1) as the teeth 260 ride over the teeth 262(1) provides a clicking effect similar to that provided by a conventional ratchet and pawl mechanism. The extent of flexing required is minimised by making the teeth 260, 262(1) relatively low profile in order to provide only the minimum engagement necessary for initiating clockwise rotation and is enabled by the clearance between the inner sidewall of the split ring and the ramps 234 and inclined surfaces 248(1).

The driven member 218 and split ring 236(1) may be configured such that only the rearmost one or two shoulders 259(1) engage opposed shoulders 261 of the driven member and, as illustrated in FIG. 11, there is a clearance between the other pairs of opposed shoulders 259(1), 261. In order for the repositioning of the lever arm 214 to occur, the driven member 218 has to remain substantially stationary. For this, it is necessary to rely on a force resisting anticlockwise rotation of the driven member 218 provided by the object received in the socket 230. It has been found that if only the rearmost one or two pairs of shoulders abut, the amount of resistance to anticlockwise rotation of the wrench head 212 and so the amount of opposing force that must be provided by the object received in the socket 230 is minimised.

In the example wrenches illustrated by FIGS. 4 to 12, it can be advantageous to have all of the teeth on the wrench head and torque transmitter engage and disengage simultaneously as this can result in stress equalisation around the interface between the two parts and reduce the likelihood of wear points forming.

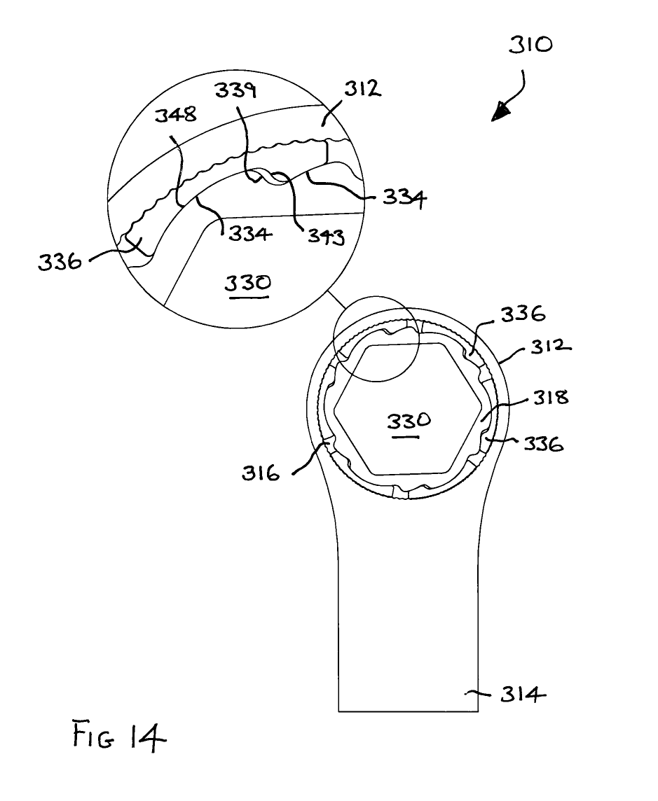

The previously described wrenches have a torque transmitter that is generally radially expanded in order to lock the wrench head to the driven member so that the two parts rotate together with the torque applied by the lever arm transmitted to the driven member by the torque transmitter. FIGS. 13 and 14 are schematic illustrations of a wrench 310 in which the torque transmitter is generally radially contracted, or compressed, to lock the wrench head and driven member. Parts of the wrench 310 that are the same as, or similar to, parts of the wrench 10 are given the same reference numerals incremented by 300 and may not be described again.

The wrench 310 comprises a wrench head 312 and a lever arm 314. The wrench head 312 is provided with a through-passage that defines a generally cylindrical chamber 316. The axis of the chamber 316 extends through and generally perpendicular to the longitudinal axis of the lever arm 314.

A driven member 318 is housed for rotation in the chamber 316 such its axis of rotation is coaxial with the axis of the chamber. The driven member 318 is a generally annular solid body having an axially extending through-hole that defines a socket 330 to receive a suitably sized and shaped object to which a torque is to be applied via the wrench 310. In the illustrated example, the socket 330 has a hexagonal profile sized to receive a particular size of nut and fastener head.

In this example, in the same way as the wrench 210, the torque transmitter comprises a plurality of bodies, which in the current example take the form of a plurality of resilient arcuate segments 336. Although not to be taken as limiting, in the illustrated example, the wrench 310 has six arcuate segments 336 disposed at circumferentially spaced apart intervals about the driven member 318. The arcuate segments 336 are disposed between the wrench head 312 and driven member 318 so as to be engagable with both for transmitting an applied torque from the wrench head to the driven member.

The outer sidewall of the driven member 318 is provided with a series of circumferentially spaced recesses 332 that define a plurality of circumferentially spaced apart camming surfaces, or ramps, 334. The ramps 334 are inclined in the circumferential direction of the outer sidewall of the driven member 318. In their lengthways direction the ramps 334 are curved, rather than flat, and initially rise relatively steeply from their radially inner ends 335 before rising more gently towards their radially outer ends 337. In some examples, there may be little or no rise at the radially outer ends 337 of the ramps 334. The recesses 332 that define the ramps 334 are configured such that the lengths of the ramps differ. Specifically, in the illustrated example, the recesses define alternating short and then long ramps. The recesses 332 also define respective shoulders 339 (FIG. 14) that connect the ramps 334 of adjacent recesses. The shoulders 339 are generally flat and extend at least approximately radially with respect to the driven member 318.

The arcuate segments 336 each comprise a recess 341 that defines an inclined surface 348. The arcuate segments are positioned such that the inclined surfaces 348 are disposed generally opposite a long ramp 334 with a gap between the inclined surfaces and ramps. The inclined surfaces 348 are configured to generally complement the incline of the long ramps 334 and for that reason curve in their lengthways direction. The recesses 341 are disposed intermediate the ends 349, 351 of the arcuate segments such that the ends are thicker than the midsection of the segments. The recesses 341 are configured such that a shoulder 343 is defined at the end of the inclined surfaces 348 adjacent the end 351 of the arcuate segments 336. The shoulders 343 are disposed opposite respective shoulders 339 and may be configured to complement the shoulders 339.

The arcuate segments 336 have a length in the circumferential direction of the driven member 318 that is approximately equal to the combined length of an adjacent long and short ramp 334. As shown in FIG. 13, when the wrench is in a non-torque applying condition, the arcuate segments 336 are only in contact with the driven member 318 via their ends 349, 351. Specifically, the ends 349 of the arcuate segments 336 engage the radially inner ends 335 of the respective opposed long ramps 334 and the ends 351 engage the radially outer ends 337 of the respective opposed short ramps 334.

The curvature of the arcuate segments 336 when in a relaxed condition and the respective nominal diameters of the sidewalls of the chamber 316 and driven member 318 are such that in the non-torque applying condition shown in FIG. 13 the outer sidewalls of the arcuate segments are in engagement with the sidewall of the chamber 316 only at a location intermediate the ends 349, 351 and the segments are compressed in the radially inwards direction of the driven member. This means that the arcuate segments are biased into engagement with the wrench head 312 by their own resilience.

The sidewall of the chamber 316 is provided with a series of teeth 360 that extend generally parallel to the axis of the chamber. The teeth 360 are disposed side by side so that in the circumferential direction of the sidewall of the chamber 316 they define a continuous series of alternating projections and depressions. The outer sidewalls of the arcuate segments 336 are provided with a series of teeth 362 that complement the teeth 360 and define a continuous series of alternating projections and depressions, which in the illustrated example extend at least substantially between the two ends 349, 351 of the segments.

Although not shown, the wrench 310 may be provided with an annular support wall and sealing element to retain the driven member 318 and arcuate segments 336 in the chamber 316 and determine the extent of the axial movement permitted in a similar way to the wrench 10. Alternatively, the annular support wall may be omitted and a second sealing element used. Another alternative would be to use a combination of a snap ring and sealing elements as shown in FIG. 8 in which case, there would be two sets of arcuate segments disposed one on each side of the snap ring.

Starting from non-torque applying condition shown in FIG. 13, if a user wishes to use the wrench 310 to apply a torque to an object received in the socket 330, a clockwise force is applied to the lever arm 314 to cause the wrench head 312 to rotate in a clockwise direction. Due to the engagement of the teeth 360, 362, which at that stage is maintained by the resilience of the arcuate segments 336, the segments rotate clockwise with the wrench head 312. As the ends 349 of the arcuate segments 336 move along the opposed long ramps 334 the radially outwards component of the movement caused by the incline of the ramps 334 and the generally radially inwards reaction force provided by the wrench head causes the segments to deform by flexing generally radially inwardly, thereby bringing an increasingly greater length of the inclined surfaces 348 into engagement with the ramps 334. The generally radially inwards deformation of the arcuate segments 336 flattens the segments until they reach the torque applying condition shown in FIG. 14. In this condition, the arcuate segments are firmly wedged between the wrench head 312 and driven member 318 so that the two parts are locked for rotation together.

To reposition the lever arm 314 during a torque applying operation, the user applies an anticlockwise force to the lever arm to cause the wrench head 312 to rotate anticlockwise. Due to the engagement between the teeth 360 on the wrench head and the teeth 362 on the arcuate segments 336, the segments are caused to rotate anticlockwise with the wrench head. The rotation of the arcuate segments is circumferential with respect to the driven member 318 and sidewall of the chamber 316. As the arcuate segments 336 rotate anticlockwise, the ends 349 of the segments move back down the ramps 334. The arcuate segments 336 continue to rotate anticlockwise with the wrench head 312 until the shoulders 343 abut the respective opposed shoulders 339 of the driven member, which prevents further anticlockwise movement of the arcuate segments. This positions the arcuate segments 336 relative to the driven member 318 such that they can bow generally radially outwardly until the wrench head 312 is freed from the driven member 318 so that it can rotate relative to the driven member. At that stage, by continuing to apply an anticlockwise force to the lever arm 314, the user is able to reposition the lever arm relative to the object that is received in the socket 330.

During repositioning of the lever arm 314, the wrench head 312 moves relative to the arcuate segments 336 and the driven member 318. Referring to FIG. 13, due to the resilience of the arcuate segments, their bowed condition and the respective gaps between the ramps 334 and inclined surface 348, the radially outermost portions of the segments that are in engagement with the teeth 360 of the wrench head 312 are able to flex generally radially inwardly to allow the teeth 360 to disengage the teeth 362 on the outer sidewall of the arcuate segments as they move past the arcuate segments. This provides a clicking effect similar to that provided by a ratchet and pawl mechanism of a conventional ratchet mechanism. The extent of the movement required to allow this action can be reduced by ensuring that the teeth 360, 362 have a low profile (ie the height of the teeth in the radial direction of the wrench 310 is kept as low as possible while providing sufficient interference to ensure that the arcuate segments move clockwise with the wrench head when a torque is to be applied.

Referring to FIG. 13, it can be seen that in the non-torque applying condition the configuration of the wrench 310 is such that the contact between the wrench head 312 and the arcuate segments 336 is along a relatively short portion of the length of the arcuate segments (viewed in the circumferential direction of the driven member). This reduces the interference between the wrench head and arcuate segments during lever arm repositioning operations. This is desirable since the resistance to anticlockwise rotation of the driven member 318 that is required to allow repositioning must be greater than the interference between the wrench head and arcuate segments and so a low interference allows the ratcheting action even when the object that is being worked is relatively loosely held by the object from which it is being removed.

The configuration of the wrench 310 is such that when the arcuate segments 336 are deformed into the torque applying condition shown in FIG. 14, there is contact between the wrench head 312 and segments along substantially the whole length of the outer sidewall of the segments. Similarly, the inner sidewall of the arcuate segments 336, which includes the inclined surfaces 348 engages an adjacent short and long ramp 334 over substantially all of its length. The result is that between the outer sidewall of the arcuate segments 336 and the sidewall of the chamber 316 there is contact over most of the circumference of the chamber sidewall. There are breaks in the contact between the wrench head and arcuate segments in the form of the gaps between adjacent arcuate segments. However, by suitably configuring the parts, it can be ensured that there is contact over at least 300° of the circumference of the inner sidewall. With regard to the contact between the outer sidewall of the driven member and the inner sidewall of the arcuate segments, again there are breaks in contact in the form of the gaps between adjacent segments. There are also gaps between the shoulders 339, 343. These gaps are needed to allow reverse rotation of the arcuate segments a distance sufficient to allow the segments to flex and release the lock between the wrench head 312 and driven member 318. By suitable configuration of the parts, the size of these gaps can be minimised so that there is contact between the arcuate segments and the outer sidewall of the driven member 318 over at least 300° of the circumference of the outer sidewall of the driven member.

It can be advantageous to have the teeth 360, 362 engage and disengage evenly and simultaneously as between each arcuate segment as this can result in stress equalisation around the interface between the parts and reduce the likelihood of wear points forming.

While a wrench having a torque transmitter comprised of a plurality of arcuate segments may be more difficult to assemble that one that has a split ring, such wrenches should still be economical to manufacture as the arcuate segments are identical in shape and can be made simply by a metal injection moulding process.

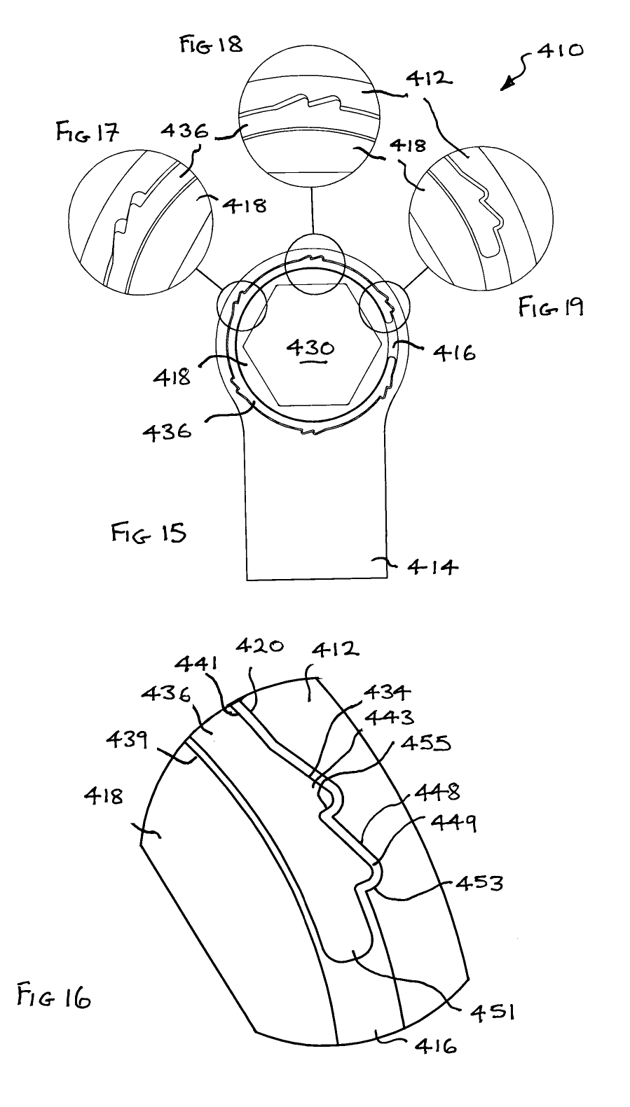

FIGS. 15 to 19 are schematic illustrations of another wrench 410 in which the torque transmitter is generally radially contracted, or compressed, to lock the wrench head and driven member. Parts of the wrench 410 that are the same as, or similar to, parts of the wrench 10 are given the same reference numerals incremented by 400 and may not be described again.

The wrench 410 comprises a wrench head 412 disposed at one end of a lever arm 414. The wrench head 412 has a through-hole that extends perpendicular to the axis of the lever arm 414 to define a chamber 416 in which a driven member 418 is housed.

The driven member 418 is a generally cylindrical body provided with an axially extending through-hole, or socket, 430. In the illustrated example the socket 430 is hexagonal in cross-section to allow it to receive a particular size of nut or fastener head.

A torque transmitter in the form of a resilient split ring 436 is disposed in the chamber 416 between an inwards facing sidewall 420 of the wrench head that defines the circumference of the chamber and an outwards facing sidewall 439 of the driven member 418. The outer sidewall 441 of the split ring 436 is provided with a plurality of projections 343 that define respective camming surfaces or ramps 434. The ramps 434 are inclined with respect to the outer sidewall 341 in the circumferential direction of the split ring.

The projections 443 are received in respective recesses 449 provided in the inwards facing sidewall 420 of the wrench head 412. The recesses 449 define respective inclined surfaces 448 that are engagable by the ramps 434 of the split ring 436. The inclined surfaces 448 are inclined in the circumferential direction of the inwards facing sidewall 437 to complement the slope of the ramps 434 of the split ring.

Although not shown, the wrench 410 may be provided with an annular support wall and sealing element to retain the driven member 418 and split ring 436 in the chamber 416 and determine the extent of the axial movement permitted in a similar way to the wrench 10. Alternatively, the annular support wall may be omitted and a second sealing element used. Another alternative would be to use a combination of a snap ring and sealing elements as shown in FIG. 8 in which case, there would be two split rings disposed one on each side of the snap ring as shown in FIG. 8.

In use, starting from the non-torque applying rest condition shown in FIGS. 16 and 19, a torque can be applied to an object received in the socket 430 by applying a clockwise directed force to the lever arm 414 to cause the wrench head 412 to rotate in a clockwise direction. At this stage, the wrench head 412 is not in engagement with the split ring 436 or makes only very light contact with the split ring so that it is able to rotate relative to the split ring. The clockwise movement of the wrench head 412 brings the inclined surfaces 448 of the wrench head to the position shown in FIG. 17 in which they engage the ramps 434 of the split ring 436. Continued clockwise movement of the wrench head 412 causes the interference between the inclined surfaces 448 and ramps 448 to increase. This causes the split ring 436 to be compressed radially inwardly, thereby tending to close the gap between the opposed ends 451 of the split ring. The effective radial shrinkage of the split ring 436 causes it to clamp onto the outer sidewall 439 of the driven member 418 to lock the driven member to the wrench head 412 so that continued clockwise rotation of the wrench head causes a torque to be transmitted to the driven member via the split ring to cause the driven member to rotate clockwise with the wrench head and apply a torque to an object received in the socket 430.

If during a torque applying operation it becomes desirable to reposition the lever arm 414, an anticlockwise force is applied to the lever arm to cause the wrench head to rotate in an anticlockwise direction. As the wrench head 412 rotates anticlockwise, the degree of interference between the ramps 434 and inclined surfaces 448 is reduced. This allows the split ring 436 to expand radially outwards and release its grip on the driven member at least to an extent that allows it to rotate relative to the driven member. As shown in FIG. 18, once sufficient anticlockwise rotation of the wrench head 412 has occurred, the trailing end faces 453 of the recesses 449 are brought into engagement with the opposed end faces 455 of the projections 443. The faces 453, 355 extend transversely of the ramps 434 and inclined surfaces 448 and generally radially with respect to the axis of rotation of the driven member 418. The engagement of the faces 453, 455 causes the split ring 436 to rotate anticlockwise with the wrench head 412. The anticlockwise rotation of the wrench head 412 and split ring 436 can then be continued until the lever arm 414 has been suitably repositioned. Further torque can then be applied to the object received in the socket 430 by again turning the lever arm 414 in a clockwise direction to put the wrench in the toque applying condition illustrated by FIG. 17.

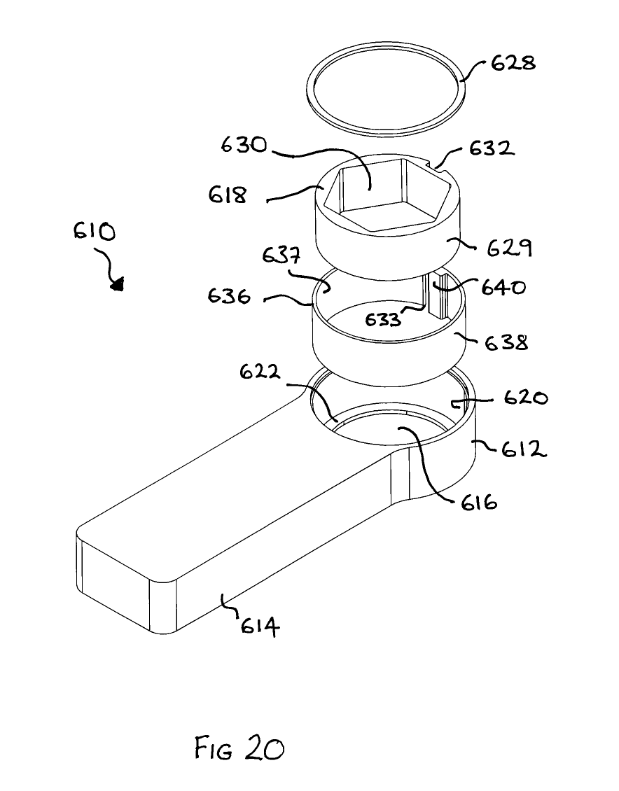

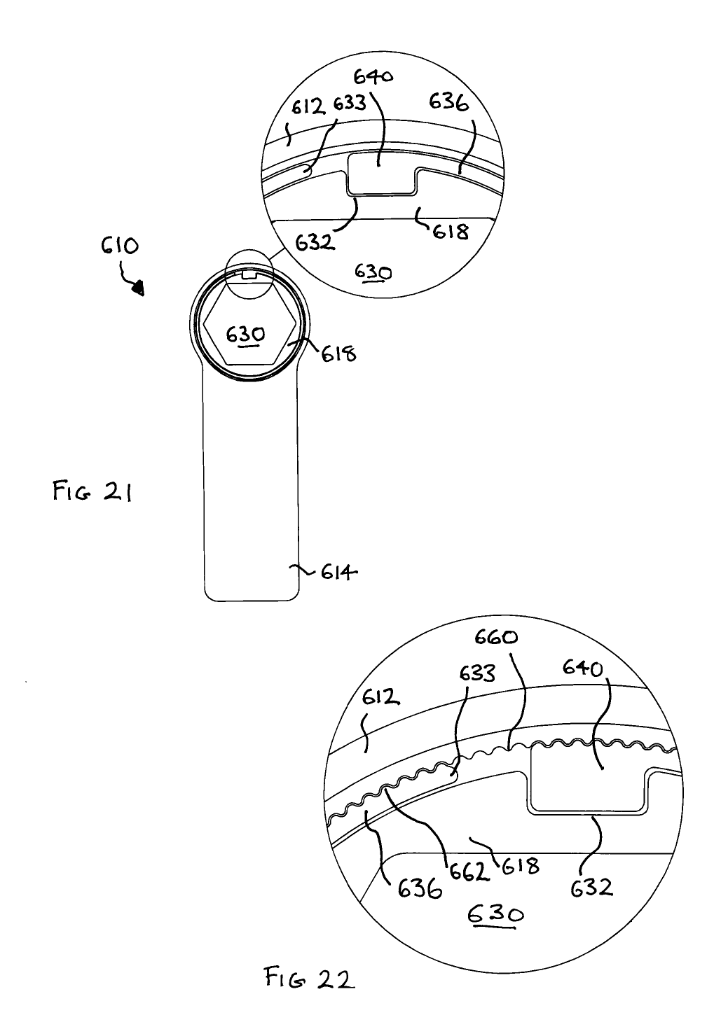

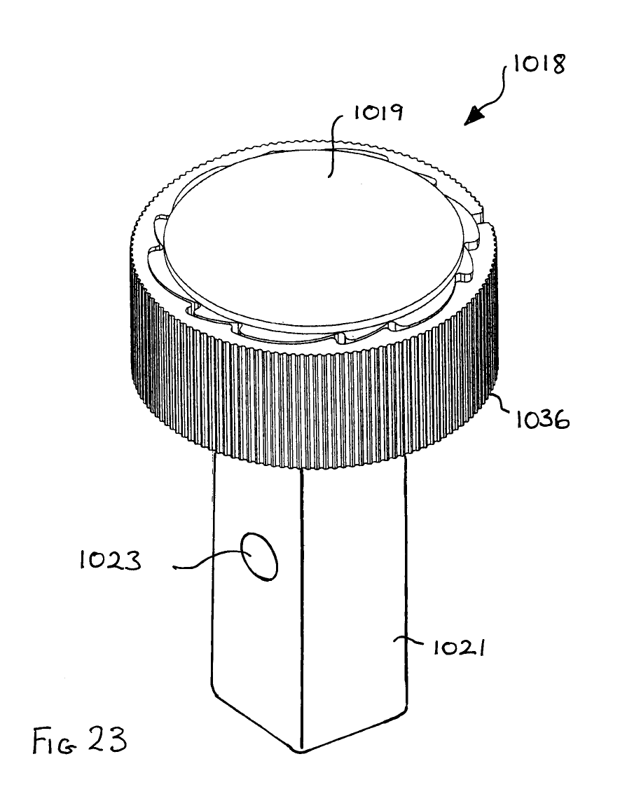

Referring to FIGS. 20 and 21 a wrench 610 having a ratchet wrench mechanism comprises a wrench head 612 and a lever arm 614. Although not essential, in the illustrated example the wrench head 612 and lever arm 614 are integral. The wrench head 612 is a generally annular body that has a generally cylindrical chamber 616. The axis of the chamber 616 extends generally perpendicular to the longitudinal axis of the lever arm 614. The chamber 616 is defined by a stepped through hole that defines a chamber sidewall 620 and a generally annular support wall 622. The sidewall 622 extends circumferentially about the axis of the chamber 616. In the illustrated example the support wall 622 is disposed substantially perpendicular to the sidewall 620 and is defined at one end of the chamber by a change in diameter of the stepped through hole.

A drive member 618 is housed for rotation in the chamber 616 such that its axis of rotation is substantially coaxial with the axis of the chamber. The driven member 618 is a generally annular body having an axially extending through hole that defines a socket 630 to receive an object to which a torque is to be applied. Although not essential, in the illustrated embodiment the socket 630 has a hexagonal profile to allow it to receive and apply a torque to a suitably sized and shaped nut or fastener head. The driven member 618 has a circumferentially extending outer sidewall 629. The sidewall 629 is provided with a generally rectangular section recess, or notch, 632. The notch 632 has a longitudinal axis that in the illustrated example is disposed in generally parallel spaced apart relation to the axis of rotation of the driven member. In the axial direction thereof the driven member 618 has a height and the notch 632 extends over the full height of the driven member.

A torque transmitter in the form of a resilient split ring 636 is disposed in the chamber 616 between the chamber sidewall 620 and outer sidewall 629 of the driven member. The split ring 636 extends around substantially the entire circumference of the outer sidewall 629. The split ring 636 has an inner circumferentially extending sidewall 637 that is provided with a radially inwardly facing projection 640. The projection 640 has a generally rectangular cross section shaped to complement the shape of the notch 632. The split ring 636 has an outer circumferentially extending sidewall 638.

When housed in the chamber 616, the driven member 618 and split ring seat on the support wall 622 with the outer sidewall 638 engaging the chamber sidewall 620. The diameters of the two sidewalls are selected such that when disposed in the chamber, the split ring is slightly compressed so that the sidewall 638 is held in engagement with the chamber sidewall 620 by a biasing force that is the product of the resilience of the split ring. A circumferentially extending groove 626 is provided at the end of the chamber 616 remote from the support wall 622 to receive the periphery of a sealing retaining ring 628. The sealing retaining ring 628 may be a plastics member that snaps into the groove 626. Axial translation of the driven member 618 and split ring 636 in the chamber 616 is limited by the support wall 622 and sealing retaining ring 628 so that the two parts are retained in the chamber. As an alternative to the support wall 622 the wrench 610 could be provided with a second sealing element. Another alternative would be to use a combination of a snap ring and sealing elements as shown in FIG. 8 in which case, there would be two sets split rings 436 disposed one on each side of the snap ring.

The ratchet operation of the wrench 610 is based on a way in which a split ring will react to the application of forces that tend to separate the ends of the split ring or move them together. Starting from the position shown in FIG. 21, if the user wishes to apply a torque to an object (not shown) received in the socket 630, an anticlockwise force is applied to the lever arm 614 to cause the wrench head 612 to rotate in an anticlockwise direction. The engagement between the outer sidewall 638 of the split ring 636 and the chamber sidewall 620 is such that the split ring tries to rotate with the wrench head 612. Initially, the end of the split ring provided with the projection 640 is prevented from moving because it is held in the recess 632 and the driven member 618 is held by the resistance to turning provided by the object received in the socket 630. The opposite end 633 of the split ring 636 is not so constrained and so rotates with the wrench head 612. The two ends of the split ring 636 are thus pushed apart slightly thereby deforming (expanding) the split ring and increasing the interference with the chamber sidewall 620. In this way the split ring 630 becomes wedged between the wrench head 612 and driven member 618 to the extent it locks the two parts together so that the driven member turns with the wrench head driven by a torque transmitted by the split ring 636.

If the user wishes to reposition the lever arm 614, the wrench head is turned clockwise by a clockwise directed force applied to the lever arm. Due to the engagement between the chamber sidewall 620 and the outer sidewall 638 of the split ring 636, the split ring tries to rotate clockwise with the wrench head 612. The end provided with the projection 640 is constrained from rotation by the resistance to turning provided by the object received in the socket 630. The opposite end 633 of the split ring 636 is not so constrained and so rotates with the wrench head 612. The two ends of the split ring are thus pulled together slightly deforming (contracting) the split ring and decreasing the interference between the split ring and chamber sidewall. When the interference between the split ring and chamber sidewall is sufficiently reduced, the wrench head is able to rotate relative to the split ring and driven member, which are held in position by the resistance to rotation provided by the object received in the socket 630. The lever arm 640 can then be repositioned relative to the driven member 618. If it is desired to apply further torque to the object received in the socket 630, this can be done by again turning the wrench head 612 anticlockwise in a repeat of the procedure described above.

FIG. 22 shows an optional modification of the wrench 610 in which the chamber sidewall is provided with teeth 660 and the split ring 636 is provided with complementary teeth 662. The teeth 660 extend generally parallel to the axis of the chamber 616 and are provided as a continuous series extending around the entire chamber sidewall 620. The teeth 660 thus provide alternating projections and depressions extending continuously around the entire circumference of the chamber 616 as defined by the chamber sidewall. The teeth 662 on the split ring 636 are provided on the outer sidewall of the split ring so as to be engagable with the teeth 660. The teeth 662 are provided as a continuous series extending between the end 633 of the split ring and the end provided with the projection 640 to provide alternating projections extending continuously between the ends of the split ring. The teeth 662 are configured to complement the teeth 660 and in the illustrated example approximate to a low profile sine wave. When provided with teeth in this way, the wrench 610 is configured such that there is sufficient clearance between the driven member 618 and chamber sidewall 620 to permit the split ring 636 to deflect generally radially inwardly a distance sufficient to allow the teeth 660, 662 to move in and out of engagement as the wrench head 612 is reverse rotated during a lever arm repositioning operation.

In the illustrated example, the driven members of the ratchet wrench heads are generally circular bodies that define a socket shaped to receive and engage an object so as to be able to apply a torque to the object. It is to be understood this is not to be taken as limiting. For example, as shown in FIG. 23 a driven member 1018 may comprise a cylindrical body 1019 an axially projecting drive spigot 1021. The driven member 1018 is shown assembled with a torque transmitter 1036 in the form of a single body having a configuration corresponding generally to the split rings 236(1), 236(2) of FIGS. 8 to 12

The drive spigot 1021 is generally polygonal. In the illustrated example the drive spigot has a rectangular cross-section with rounded corners. The drive spigot may be provided with a locking mechanism by which the drive spigot can be releasably secured to a standard size drive socket by push-fitting. The locking mechanism may comprise one or more spring loaded balls 1023 to be received in a recess(es) provided in the socket.

The drive spigot 1021 may be a fixed part of the driven member 1018. Alternatively, the drive spigot may be received in an axially extending polygonal through-hole defined by the body 1019 such that it can be slid back and forth in the through-hole. In this example, the drive spigot can be provided with two ball locking mechanisms 1023 with one usable to releasably secure the drive spigot to the cylindrical body while the other is used to secure a socket or other device to the drive spigot. Utilising such an arrangement enables a uni-directional ratchet wrench head, such as that illustrated in FIGS. 1 to 5, to be used to selectively apply a clockwise or anticlockwise torque to an object with the torque applying direction selected by simply sliding the drive spigot 1021 to the appropriate position in the cylindrical body 1019.

In a conventional ratchet wrench, the torque is transmitted from the wrench head to the driven member via one or more pawls. The area of contact between the pawl(s) and the driven member is usually relatively small. Similarly, the pawl(s) engage the wrench head over a relatively small area. This means that the loads transferred between the driven member and wrench head by the pawl(s) are transferred through relatively small areas giving rise to stress concentrations. As a consequence, the parts used in convention ratchet wrenches have to be made relatively large (thicker) in order to withstand the loading without breakage. This results in the wrench head of conventional ratchet wrenches being rather large, which reduces the usability of such wrenches in confined spaces such as, for example, the engine bay of a motor vehicle.

By way of an example, an 18 mm conventional non-ratcheting ring wrench or box wrench would have a nominal diameter of around 27 mm. The nominal wrench head diameter of a conventional 18 mm ratcheting ring wrench would typically by around 33.6 mm. An 18 mm ratchet wrench incorporating features of the examples described above can be made with a nominal diameter of about 27.8 mm, which is nearly 6 mm less than that of a conventional ratchet ring wrench.

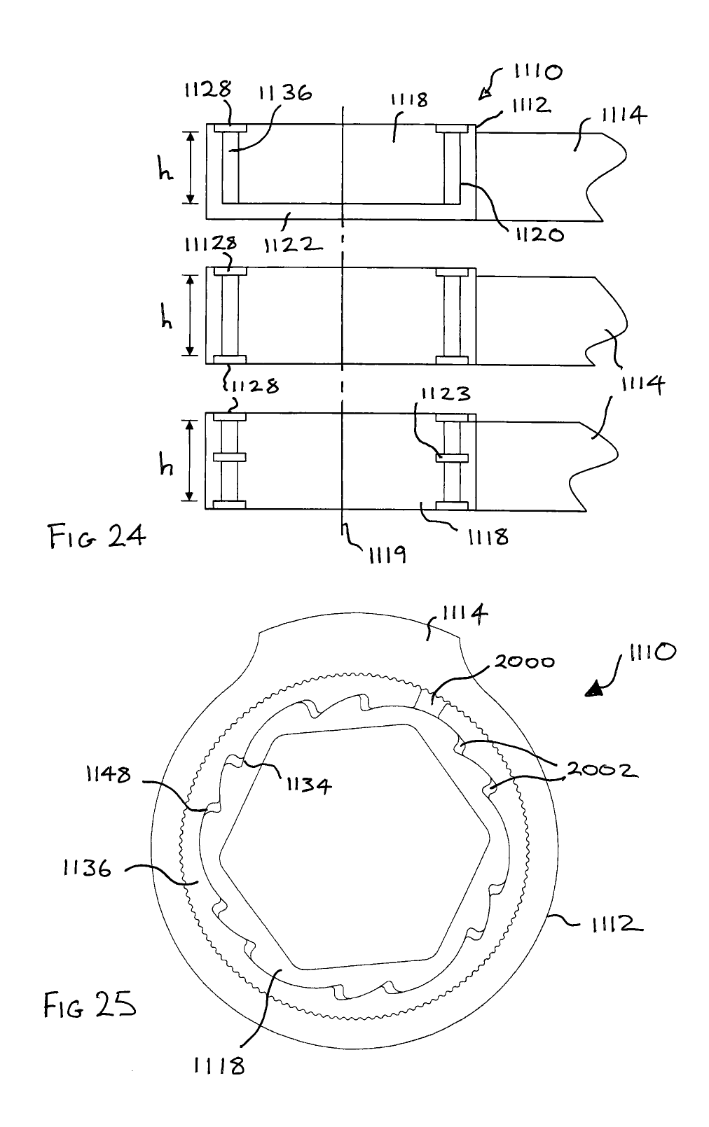

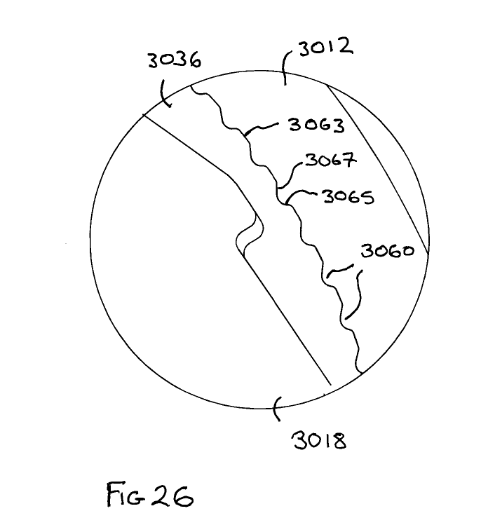

Features that can be incorporated in ratchet wrench heads configured using principles described above with reference to the illustrated examples that permit the manufacture of wrench heads having a relatively small nominal diameter as compared with conventional ratchet wrench heads will now be described with reference to FIGS. 24 and 25.

FIG. 24 shows schematically a side view of three variations of a wrench 1110 having a ratchet wrench head. The wrench has a wrench head 1112 connected with a lever arm 1114. Working from the top of the page towards the bottom, the top view show the basic configuration exemplified by FIG. 1 in which the driven member 1118 is supported on an annular support wall 1122 with a sealing retaining ring provided at the opposite end of the chamber in which the driven member is housed. The centre view shows a version in which the annular support wall is replaced by a second sealing retaining element. The bottom view shows a version having a snap ring and two sealing retaining elements as exemplified by the example shown in FIG. 8.

In each case the chamber 1120 has a sidewall defined by an inwards facing sidewall of the wrench head that is positioned generally opposite an outer sidewall of the torque transmitter 1136. Similarly, the torque transmitter has an inner sidewall that is positioned generally opposite an outer sidewall of the driven member 1118. These pairs of facing sidewalls each have a height h measured in the direction of the axis of rotation 1119 of the driven member 1118. These heights h are substantially the equal.

FIG. 25 is a schematic plan view of the wrench 1110 in the three versions illustrated in FIG. 24 with any sealing/sealing retaining element 1128 removed to allow the torque transmitting member 1136 to be seen. In FIG. 25 the wrench is shown with the torque transmitter in a toque applying condition. It can be seen that over an imaginary, or hypothetical, circle drawn at the interface of the inwards facing sidewall of the wrench head that defines the chamber sidewall 1120 and the outer sidewall of the torque transmitter 1136 there is substantially continuous contact between the two sidewalls, except at the gap 2000 between the two ends of the torque transmitter. Similarly, it can be seen that over an imaginary or hypothetical circle drawn at the interface of the inner sidewall of the torque transmitter and the outer sidewall of the driven member there substantially continuous contact except at the gap 2000 and the gaps 2002 between the facing shoulders on the driven member and torque transmitter that are need to allow the torque transmitter to reverse sufficiently to release the wrench head for lever arm repositioning operations. The extent of the gaps 2000, 2002 can be minimised by the configuring the ramps 1134 of the driven member 1118 and inclined surfaces 1148 of the torque transmitter 1136 such that the deformation of the torque transmitter needed in order to lock and release the driven member requires the minimum relative rotation of the torque transmitter and driven member. For the purpose of providing maximum contact between the outer sidewall of the driven member and inner sidewall of the torque transmitter it is believed curved ramps 1134 and complementary curved inclined surfaces 1148 as shown in FIG. 25 provide the best results.

Using the configurations illustrated by FIGS. 24 and 25 it has been found possible to provide contact between the above-mentioned imaginary circles over more than 300°. Examples have been produced with contact over 325° and even a version with contact on 337.7° at the interface between the driven member and torque transmitter and 357.7° at the interface between the wrench head and torque transmitter. As a consequence of the substantially full height h contact between the respective sidewalls at the two interfaces and the extent of the contact in the circumferential direction, when locked up in a torque transmitting condition the wrench head 1112, driven member 1118 and torque transmitter 1136 form an essentially solid block of pseudo-laminate that allows the loads transferred between the wrench head and driven member to be distributed through substantially the whole circumference of the wrench head and driven member, thereby avoiding the formation of stress concentrations. This allows the wrench head 1112, driven member 1118 and torque transmitter 1136 to be made as relatively thin components (viewed in radial direction of the parts) making it possible to produce a wrench head with a relatively small nominal diameter. The pseudo-laminate structure also reduces the likelihood of damage to the components occurring during high loading operations and enhances the load transmitting capability of the wrench as compared with a conventional ratchet wrench.

For the pseudo-laminate effect, the best results are typically obtained with a torque transmitter that is a split ring. Torque transmitters comprising a plurality of arcuate segments as illustrated in FIGS. 13 and 14 will usually provide lower interface contact due to the gaps between the segments. Such torque transmitters are also expected to slightly reduce the potential to reduce the nominal diameter of the wrench head as the radial component of movement of the arcuate segments may need to be greater than that needed for a split ring. However, it is to be expected that there will still be a significant improvement as compared with a conventional ratchet wrench.

For best results in example wrenches that have teeth at the interface of the chamber sidewall and the torque transmitter, the configuration of the teeth is selected to maximise the contact at the interface. It is to be noted that the teeth can be designed so that there is full contact between them at the interface. When the wrench head is reverse rotated from the locked condition, the torque transmitter is deflected generally radially inwardly to allow the teeth on the wrench head to disengage and ride over the teeth on the torque transmitter. It is thus not necessary to provide clearance at the crests of the teeth that is needed to give the rolling motion of two gear wheels.

In order to have full tooth contact, it is desirable that the two sets of teeth are identical in shape and size. However, there is a difference in the diameter of the chamber sidewall and torque transmitter outer sidewall. It has been found that this problem can be overcome selecting the number and ratio of teeth provided on the two circumferences such that if the split ring extended for a full 360° degrees there would be at least one more tooth on the chamber sidewall as compared with the outer sidewall of the split ring. The number and ratio of teeth is selected according to the amount of deflection of the torque transmitter needed to obtain sufficient tooth disengagement for reverse rotation of the wrench head. Referring again to the imaginary circle at the interface between the chamber sidewall and outer wall of the torque transmitter, if teeth were provided around the full 360° of the circle, the number of teeth chosen would be such that there would be one or two more on the chamber sidewall.

It is generally desirable that the teeth used should have a low profile so that the amount of the deflection, or deformation of the torque transmitter required for it to move between its torque applying and non-torque applying repositioning conditions is relatively small. If the amount of deflection is kept small, the amount of relative rotational movement required of the parts can be reduced with the aim of minimising the amount of wasted movement during use of the wrench. In principle, the tooth height need only be sufficient to enable the wrench head to initiate movement of the torque transmitter overcoming any friction between the torque transmitter and the driven member.

Examples of tooth profiles that may be used are shown in FIGS. 4, 5, 13 and 22. FIGS. 5 and 13 illustrates teeth that comprise a low arch disposed side by side with a small reverse arc at the point of intersection the ends of adjacent arches. FIG. 22 shows a substantially full sinusoidal tooth form. This form may be improved on by replacing the curved peaks and troughs of the waveform with respective flats so as to reduce the height of the teeth. FIG. 26 shows a tooth form in which the teeth 3060 on the wrench head 3012 are comprise have a radius peak and sloping sides are separated relatively flat portions 3063. The sloping sides are slope at different rates. The side 3065 of the teeth 3060 that is the leading side when the torque transmitter 3036 has a steeper slope than the side 3067 that is the leading side when the torque transmitter is reverse rotated to release the driven member 3018 from locking engagement with the wrench head. The teeth 3062 on the torque transmitter 3036 have an inverse form to the teeth 3060 so that the two sets of teeth can mate with substantially full surface contact as shown in FIG. 26. The steeper slope of the side 3065 assists in ensuring there is sufficient interference between the two sets of teeth to ensure the torque transmitter is reliably and substantially instantaneously rotated with the wrench head when the wrench head is rotated clockwise to cause the torque transmitter to be deformed into a torque applying condition. The less steep of the sides 3067 reduces the force needed to allow the teeth to disengage when the wrench head 3012 is reverse rotated relative to the torque transmitter during lever arm repositioning operations.

If the driven member of the wrench has an aperture defining a polygonal socket, such as in the case of the example shown in FIGS. 1 to 5, the thinnest sections of the driven member will be at the corners of the socket and are potentially the weakest point of the driven member. If the driven member is provided with recesses to define ramps as shown in FIGS. 1 to 5, these should be positioned away from the corners of the socket and, preferably, midway between them. The recesses may be configured such as to reduce the driven member thickness at the location at which they are formed such that it approximates to the thickness at the corners of the socket so as to equalise the potential points of weakness and distribute them relatively evenly around the circumference of the driven member.

In the illustrated examples, the ratchet wrench heads are shown as integral with the lever arm and one example is shown with an open ended wrench head provided at the end of the lever arm opposite the ratchet wrench head. It is to be understood that these examples are not to be taken as limiting. For example, the lever arm may be pivotally connected with the ratchet wrench head via clevis joint or may be releasably attachable to the ratchet wrench head. Alternatively, for wrenches in which the ratchet wrench head is integral with one end of a lever arm, a different sized ratchet wrench head or conventional non-ratcheting ring head provided at the other end.

While not to be taken as limiting, the wrench head may be produced by drop forging and the broaching the chamber, while the torque transmitter may be produced as a metal extrusion and the driven member may be produced by metal injection moulding or pressure die casting. These methods can be convenient and economic, although, many other production techniques known to the skilled person can also be suitable.

In some examples of the wrench the torque transmitter is shown as a split ring with ends that are disposed in opposed spaced apart relation. In another non-illustrated example, the ends of the split ring may be interconnected by a resilient member. Alternatively, the ends may be inclined and/or overlapping.

The example wrenches have a wrench ratchet mechanism that has an arcuate torque transmitter or locking member that is deformable when the torque transmitter is rotated relative to the driven member by rotation of the wrench head in a first direction. The deformation of the torque transmitter locks the wrench head to the driven member so that a torque applied to the wrench head via a lever arm is transmitted to the driven member, which rotates with the wrench head. When the torque transmitter is rotated in a second direction opposite the first direction, the driven member is released and the torque transmitter can deform to a non-torque applying condition in which the wrench head can rotate relative to the driven member and torque transmitter to allow repositioning of the lever arm. A cam system may be incorporated in the mechanism to cause the deformation of the torque transmitter when the wrench head is rotated in the first direction. In some examples, the torque transmitter is resilient biased into engagement with the wrench head so that it moves with the wrench head when the wrench head is rotated in the first direction. The torque transmitter and wrench head may be provided with interengagable teeth to ensure the torque transmitter and wrench head rotate together in the first direction. When such teeth are provided, the cam system is configured to permit the torque transmitter to be deformed by the teeth of the wrench head acting on the teeth of the torque transmitter as the wrench head moves relative to the torque transmitter so that the teeth can move in and out of engagement as the crests of the two sets of teeth ride over one another.

In the description reference is made to clockwise and anticlockwise movements. This refers only to the directions as seen in the relevant drawings and is not to be taken as limiting.

In the context of this application, a wrench ratchet mechanism and a ratchet wrench head are devices able to apply a torque in one direction and allow repositioning of the wrench head relative to an object to which a torque is being applied while the wrench head, or a socket or the like attached to the wrench head, remains engaged with the object.

1. A wrench ratchet mechanism comprising:
a driven member;
a housing having a chamber in which said driven member is at least partially received; and
a torque transmitter disposed between said housing and said driven member to transmit an applied torque from said housing to said driven member,
wherein said driven member has an axis of rotation and is rotatable about said axis in response to said applied torque and wherein said torque transmitter is deformable from a non-torque transmitting condition to a torque transmitting condition in response to rotation of said housing in a first direction and wherein said torque transmitter is returnable to said non-torque transmitting condition in response to rotation of said housing in a second direction that is opposite said first direction.

2-3. (canceled)

4. A wrench ratchet mechanism as claimed in claim 1, wherein said torque transmitter comprises a resiliently deformable torque transmitting member that resiles from said torque transmitting condition to said non-torque transmitting condition in response to rotation of said housing in said second direction.

5. A wrench ratchet mechanism as claimed in claim 1, wherein said torque transmitter comprises a split ring that at least partially encircles said driven member.

6. (canceled)

7. A wrench ratchet mechanism as claimed in claim 1, wherein said torque transmitter has a circumferential direction and comprises a plurality of arcuate segments disposed in circumferentially spaced apart relationship about said driven member.

8. A wrench ratchet mechanism as claimed in claim 1, wherein said torque transmitter has a circumferential direction and is provided with at least one first inclined surface that is inclined in said circumferential direction and engagable with at least one second inclined surface provided on one of said housing and said driven member to cause deformation of said torque transmitter in response to rotation of said housing in said first direction.

9. A wrench ratchet mechanism as claimed in claim 8, wherein said torque transmitter is provided with a plurality of said first inclined surfaces to engage respective said second inclined surfaces and wherein said second inclined surfaces are arranged to provide substantially continuous deformation of said torque transmitter in said circumferential direction.

10. (canceled)

11. A wrench ratchet mechanism as claimed in claim 9, wherein said second inclined surfaces comprise a plurality of first length second inclined surfaces and a plurality of second length inclined surfaces that have a length less than said first length second inclined surfaces, said second inclined surfaces being arranged to provide alternating first and second length second inclined surfaces in said circumferential direction.

12. A wrench ratchet mechanism as claimed in claim 8, wherein said at least one second inclined surface curves in said circumferential direction.

13. A wrench ratchet mechanism as claimed in claim 8, wherein said at least one second inclined surface is provided on said driven member.

14-15. (canceled)

16. A wrench ratchet mechanism as claimed in claim 1, wherein said driven member:
i) defines an aperture for receiving at least a portion of an object to which a torque is to be applied; or
ii) comprises an axially extending projection that extends from said chamber to be engagable in an aperture of an object to which a torque is to be applied.

17-18. (canceled)

19. A wrench ratchet mechanism as claimed in claim 1, comprising at least one retainer to retain said driven member in said chamber and at least limit axial translation of said driven member in said chamber, wherein said chamber has a height parallel to said axis of rotation and is provided with a circumferentially extending groove that is disposed within a 75 percent midrange of said height that is centered on mid-height and said driven member is retained in said chamber by a said retainer engaged in said groove.

20-21. (canceled)

22. A wrench ratchet mechanism as claimed in claim 1, wherein:
said driven member has an outer sidewall;
said chamber has a sidewall that faces inwardly of said housing;
said torque transmitter has an outer sidewall facing said chamber sidewall and an inner sidewall facing said outer sidewall of said driven member;
said torque transmitter has a circumferential direction and is configured such that when in said torque transmitting condition in said circumferential direction there is contact between:
i) said inner sidewall of said torque transmitter and said outer sidewall of said driven member through at least 90 degrees of a hypothetical circle extending around said driven member between said driven member and said torque transmitter; and
ii) said outer sidewall of said torque transmitter and said inwards facing sidewall of said housing through at least 90 degrees of a hypothetical circle extending around said torque transmitter between said inwards facing sidewall and said torque transmitter.

23. A wrench ratchet mechanism as claimed in claim 22, wherein said axis of rotation defines an axial direction and in said axial direction said inner sidewall of said torque transmitter has a first height and said outer sidewall of said torque transmitter has a second height and wherein at least one of:
i) said contact between said inner sidewall of said torque transmitter and said outer sidewall of said driven member is over substantially all of said first height; and
ii) said contact between said outer sidewall of said torque transmitter and said inwards facing sidewall of said housing is over substantially all of said second height,
wherein in said axial direction said inwards facing sidewall of said housing has a third height and said outer sidewall of said driven member has a fourth height and wherein at least one of:
i) said first height is substantially equal to said fourth height; and
ii) said second height is substantially equal to said third height, and
wherein said first, second, third and fourth heights are substantially equal.

24-27. (canceled)

28. A wrench ratchet mechanism as claimed in claim 22, wherein said contact is through at least 270 degrees of said hypothetical circle.

29. A wrench ratchet mechanism as claimed in claim 22, wherein said at least 90 degrees contact is a sum of a plurality of contacts at spaced apart locations on said hypothetical circle.

30. A wrench ratchet mechanism as claimed in claim 1, wherein said torque transmitter is biased into engagement with said housing whereby rotation of said housing in said first direction causes rotation of said torque transmitter to a position at which said torque transmitter is deformed to said torque transmitting condition.

31. A wrench ratchet mechanism as claimed in claim 30,
wherein said torque transmitter comprises a split ring, and
wherein rotation of said housing in said second direction causes rotation of said torque transmitter in said second direction, said torque transmitter has an end that is a trailing end when said torque transmitter rotates in said second direction and said trailing end of said torque transmitter is provided with a first shoulder and said driven member is provided with a second shoulder facing said first shoulder, said first shoulder being engagable with said second shoulder to limit rotation of said torque transmitter in said second direction.

32. A wrench ratchet mechanism as claimed in claim 31, wherein said torque transmitter has a circumferential direction and has a plurality of first shoulders at circumferentially spaced apart locations and said driven member has respective said second shoulders facing said first shoulders, said first and second shoulders being arranged such that only said first shoulder at said second end of said torque transmitter and the said facing second shoulder are engagable.

33. A wrench ratchet mechanism as claimed in claim 1, wherein said chamber has a circumference and is provided with a series of first teeth at spaced apart locations around said circumference and said torque transmitter is provided a series of second teeth that are engagable with said first teeth, said first and second teeth being configured to provide substantially full surface contact therebetween when said torque transmitter is in said torque applying condition.

34. A wrench ratchet mechanism as claimed in claim 33, wherein each said tooth has a height and a base width and said base width is greater than said height.

35. A wrench ratchet mechanism comprising:
a driven member having an outer sidewall;
a housing having an inwards facing sidewall that at least partially defines a passage in which said driven member is at least partially received, said passage having a longitudinal axis defining an axial direction; and
an arcuate torque transmitter disposed between said driven member and said housing and extending at least partially around said driven member in a circumferential direction thereof, said torque transmitter comprising an outer sidewall facing said inwards facing sidewall of said housing and an inner sidewall facing said outer sidewall of said driven member and in response to rotation of said housing in a first direction being movable between a torque transmitting condition in which it causes said driven member to rotate with said housing and a non-torque transmitting condition in which said housing can rotate relative to said driven member, and said torque transmitter being configured such that when in said torque transmitting condition in said circumferential direction there is contact between:
i) said inner sidewall of said torque transmitter and said outer sidewall of said driven member through at least 90 degrees of a hypothetical circle extending around said driven member between said driven member and said torque transmitter; and
ii) said outer sidewall of said torque transmitter and said inwards facing sidewall of said housing through at least 90 degrees of a hypothetical circle extending around said torque transmitter between said inwards facing sidewall and said torque transmitter.

36. A wrench ratchet mechanism as claimed in claim 35, wherein in said axial direction said inner sidewall of said torque transmitter has a first height and said outer sidewall of said torque transmitter has a second height and wherein at least one of:
i) said contact between said inner sidewall of said torque transmitter and said outer sidewall of said driven member is over substantially all of said first height; and
ii) said contact between said outer sidewall of said torque transmitter and said inwards facing sidewall of said housing is over substantially all of said second height.

37. A wrench ratchet mechanism as claimed in claim 36, wherein in said axial direction said inwards facing sidewall of said housing has a third height and said outer sidewall of said driven member has a fourth height and wherein at least one of:
i) said first height is substantially equal to said fourth height; and
ii) said second height is substantially equal to said third height.

38. A wrench ratchet mechanism as claimed in claim 37, wherein said first, second, third and fourth heights are substantially equal.

39. A wrench ratchet mechanism as claimed in claim 35, wherein said contact is through between 50 and 350 degrees of said hypothetical circle.

40. (canceled)

41. A wrench ratchet mechanism as claimed in claim 39, wherein said contact is through at least 270 degrees of said hypothetical circle.

42. A wrench ratchet mechanism as claimed in claim 35, wherein said movement of said torque transmitter between said non-torque transmitting condition and said torque transmitting condition is at least in part by deformation of said torque transmitter.

43-48. (canceled)

49. A wrench comprising a ratchet wrench head and a lever connected with said ratchet wrench head, said ratchet wrench head comprising:
a body defining a chamber having an inwards facing sidewall;
a driven member at least partially housed in said chamber and rotatable therein about an axis of rotation, said driven member having an outwards facing sidewall and a formation to engage an object to which a torque is to be applied;
at least one arcuate member disposed between said inwards and outwards facing sidewalls; and
a cam system configured to shape change said at least one arcuate member from a non-torque transmitting shape to a torque transmitting shape in response to rotation of said housing in a first direction,
wherein when in said torque transmitting shape said at least one arcuate member is forced into locking engagement with said body and said driven member to lock said driven member to said body whereby a torque applied to said body by said lever arm is transmitted to said driven member via said at least one arcuate member to be applied to said object.

50. A wrench as claimed in claim 49, wherein said cam system comprises a plurality of cam surfaces defined by said inwards facing sidewall and configured to shape change said at least one arcuate member by pressing said at least one arcuate member inwardly against said outwards facing sidewall of said driven member in response to rotation of said body in said first direction relative to said at least one arcuate member.

51. A wrench as claimed in claim 49, wherein said cam system comprises a plurality of cam surfaces defined by said outwards facing surface of said driven member and configured to shape change said at least one arcuate member by pressing said at least one arcuate member outwardly against said inwards facing sidewall of said body in response to rotation of said at least one arcuate member with said body in said first direction.

52. A wrench as claimed in claim 49, comprising a plurality of said arcuate members and wherein said cam system comprises respective cam surfaces defined by said outwards facing side wall of said driven member and configured to shape change said arcuate members by bowing said arcuate members into increasing engagement with said outwards facing sidewall in response to rotation of said arcuate members with said body in said first direction.

53. A wrench as claimed in claim 52, wherein said respective cam surfaces comprise a first cam engaged with a first end of the respective arcuate member and a second cam spaced from said first cam surface and engaged with a second end of the respective arcuate member, said first and second cams being configured to move said ends away from said driven member when said wrench head is rotated in said first direction.

54. (canceled)

55. A wrench as claimed in claim 51, wherein said at least one arcuate member and chamber are provided with respective tooth sets having respective tooth profiles configured to provide substantially full surface engagement when said at least one arcuate member locks said driven member to said body.

56. A wrench as claimed in claim 55, wherein said cam system is configured to permit said at least one arcuate member to at least partially deform towards said axis of rotation to permit disengagement of said tooth sets to permit rotation of said body relative to said at least one arcuate member in a second direction opposite to said first direction.

57. (canceled)
